(19) United States
(12) Patent Application Publication
(10) Pub. No.: US 2008/0063875 A1
(43) Pub. Date: Mar. 13, 2008

(54) High heat distortion resistant inorganic laminate

(76) Inventors: John W. Robinson, Fernandina Beach, FL (US); Craig L. Cartwright, Jacksonville, FL (US); Anthony M. Mazany, Amelia Island, FL (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/978,920

(22) Filed: Oct. 30, 2007

Related U.S. Application Data
(63) Continuation-in-part of application No. 10/858,624, filed on Jun. 2, 2004.
(63) Continuation-in-part of application No. 10/777,885, filed on Feb. 12, 2004, now Pat. No. 7,094,285.
Application No. 10/777,885 is a continuation-in-part of application No. 09/871,765, filed on Jun. 1, 2001, now Pat. No. 6,966,945.
Application No. 10/777,885 is a continuation-in-part of application No. 09/871,998, filed on Jun. 1, 2001, now Pat. No. 6,969,422.
(60) Provisional application No. 60/476,671, filed on Jun. 6, 2003.
(60) Provisional application No. 60/233,952, filed on Sep. 20, 2000.
(60) Provisional application No. 60/233,985, filed on Sep. 20, 2000.

(51) Int. Cl. B32B 17/06; B32B 9/04

(52) U.S. Cl. 428/426; 428/446; 428/454

(57) ABSTRACT

A light-weight, heat distortion resistant laminate includes at least one layer of an alkali silicate resin composition derived from an alkali silicate and/or alkali silicate precursor, at least one oxoanionic compound or a reactive acidic glass; and water; and at least one reinforcing core layer comprising an inorganic high-temperature resistant composition. The laminate has a very low quench steepness index value upon rapid quenching as with ambient temperature water.

### CROSS REFERENCE TO RELATED APPLICATIONS

This application is a continuation-in-part application of U.S. patent application Ser. No. 10/858,624, filed Jun. 2, 2004 entitled “Multi-Layer Fire-Resistant Systems”, which is a continuation-in-part of U.S. Provisional Patent Application 60/476,671, filed Jun. 6, 2003, entitled “Fire Resistant Barrier”. U.S. patent application Ser. No. 10/858,624, filed Jun. 2, 2004, entitled “Multi-Layer Fire-Barrier Systems”, is a continuation-in-part of U.S. patent application Ser. No. 10/777,885, filed Feb. 12, 2004, entitled “Inorganic Matrix Compositions, Composites incorporating the Matrix, and Process of Making the Same” which in turn is a continuation-in-part of U.S. patent application Ser. No. 09/871,765, filed Jun. 1, 2001, which in turn claims the benefit of U.S. Provisional Patent Application 60/233,952, filed Sep. 20, 2000, entitled “Inorganic Matrix Compositions, Composites and Process of Making the Same”. U.S. patent application Ser. No. 10/777,885 also is a continuation-in-part of U.S. patent application Ser. No. 09/871,998, filed Jun. 1, 2001, which in turn claims the benefit of U.S. Provisional Patent Application 60/233,985, filed Sep. 20, 2000, entitled “Inorganic Matrix Compositions and Composites Incorporating the Matrix Composition”. A priority benefit is claimed with regard to all of the above applications, and the same are hereby fully incorporated herein by reference.

### FIELD OF THE INVENTION

The heat distortion resistant inorganic laminate of the present invention has desirable properties with respect to high-temperature resistance and desirable quench distortion resistance such that a low steepness index is achieved when the laminate is heated to a high temperature and rapidly quenched in a low temperature medium. The laminate comprises at least one external layer derived from the reaction product of an alkali silicate and/or alkali silicate precursors, from one or more non-silicate oxoanionic compounds or a reactive acidic glass, and water; and at least one core layer composition that is an inorganic, high-temperature resistant composition.

### BACKGROUND OF THE INVENTION

Inorganic matrices are useful as fire retardant binders for composite materials, bulk materials, adhesives, cellular materials, such as foamed materials, or composite materials. As bulk materials, they are used to form shaped objects which when cured provide a structural material. As a composite material, the matrix composition is used to impregnate a fabric, which may be combined with other similarly impregnated fabrics, to form the composite lay-up, which is then shaped and cured to form a shaped object, similar to a bulk material, but with the benefit of the reinforcement provided by the fabric.

The most familiar composite systems today are based on organic polymer matrices such as epoxy/glass fiber, epoxy/carbon fiber, polyurethane/glass fiber, PVC/glass fiber, polyimide/quartz fiber, polyester/glass fiber and nylon/glass fiber. Although organic polymer composites exhibit excellent physical and mechanical properties, they are limited with regard to flammability, smoke and gas generation and elevated service temperatures. The flammability of organic polymer-based composites can be reduced by the addition of inorganic components and/or additives. The substitution of hydrogen atoms with halogen atoms (such as for example, chlorine) in hydrocarbons and hydrocarbon polymers can significantly reduce flammability and smoke/gas generation but will degrade at temperatures greater than 250° C. and eventually incinerate at temperatures greater than 450° C. Organic thermoplastic polymers also deform at relatively low temperatures (about 100° C.-300° C.) and organic polymers designed for higher service temperatures are generally prohibitive in material and processing costs.

Other composite materials include metal matrix composites (MMC), ceramic matrix composites (CMC), carbon-carbon composites as well as other inorganic matrix composites. A composite matrix may be 100% inorganic, or it may contain some organic content. Inorganic matrix networks include ceramics, oxide based ceramics, glasses, metals, metal alloys, cementitious materials, and the like. Other materials can be considered include inorganic particles encapsulated with inorganic binders, organic resins filled with inorganic fillers, inorganic-organic hybrids such as silicone, and other inorganic matrix materials known to those knowledgeable in the arts.

Alkali silicates are employed as affordable inorganic matrix binder materials. See for example, U.S. Pat. Nos. 4,472,199; 4,509,985; 4,888,311; 5,288,321; 5,352,427; 5,539,140; or 5,798,307 to Davidovits; U.S. Pat. No. 4,936,939 to Woolum; or U.S. Pat. No. 4,284,664 to Rauch.

German Patent 3,246,604, which is a family member of U.S. Pat. No. 4,533,393, relates to molded parts reportedly having high flexural strength, based on alkali silicates that can be produced by casting and/or press-molding and curing by heating from aqueous molding compositions which are prepared from an oxide mixture containing amorphous silicic acid and aluminum oxide, as well as, optionally, as an additional component, aqueous, amorphous, disperse-powdery silicic acid, dissolved SiO₂, and alkali from alkali silicate solutions, optionally alkali hydroxide or its aqueous solutions and, if desired, fillers, by means of mixing under agitation. By addition of a blowing agent inorganic foamed products can be obtained.

### SUMMARY OF THE INVENTION

A heat distortion resistant laminate comprises at least one reinforcing core layer and at least one external metallosilicate containing layer desirably having a reinforcement therein such as a fiber. The core layer generally provides light weight and high temperature resistance and comprises an inorganic, high-temperature resistant composition containing various compounds such as refractory materials; ceramics; various oxides of aluminum, silicon, phosphorus, magnesium, titanium, or zirconium, or the like and can be in the form of a honeycomb structure, an undulating layer, etc. The laminate has favorable properties such as light weight, desirable impact resistance, high-temperature resistance and very low steepness index (distortion) values when thermally quenched.

In one aspect of the invention, a heat-quench distortion resistant laminate, comprises: at least one layer of an alkali silicate inorganic resin composition wherein said inorganic resin composition comprises a) the reaction product of an alkali silicate or alkali silicate precursors derived from an alkali hydroxide or oxide and a silicate source, or combinations thereof, one or more non-silicate oxoanionic compounds optionally including at least one phosphorus compound, water, optionally one or more compounds containing one or more multivalent cations comprising Groups 2, 3, 4, 5, 6, 7, 8, 9, 10, 11, 12, 13, 14, 15, or 16 of the periodic table or any combination thereof, and optionally a clay or an oxide filler or both; or b) the reaction product of an alkali silicate or alkali silicate precursors derived from an alkali hydroxide or oxide and a silicate source, or any combination thereof, a reactive acidic glass, water, and optionally a clay or an oxide filler or both; or c) the reaction product of an alkali silicate or alkali silicate precursors derived from an alkali hydroxide or oxide and a silicate source, or combinations thereof, one or more non-silicate oxoanionic compounds optionally including at least one phosphorus compound, a reactive acidic glass, water, optionally one or more compounds containing one or more multivalent cations comprising Groups 2, 3, 4, 5, 6, 7, 8, 9, 10, 11, 12, 13, 14, 15, or 16 of the periodic table or any combination thereof, and optionally a clay or an oxide filler or both; and at least one core layer, said core layer comprising an inorganic composition having a thermal resistance of at least about 640° C.; and said laminate having a quench steepness index value of about 2% or less in a lateral direction according to modified ASTM Test A 1030/A 1030M-05.

### BRIEF DESCRIPTION OF THE DRAWINGS

The invention comprises compositions, laminates, and improvements shown and described. The accompanying drawings that are incorporated and constitute a part of the specification illustrate embodiments of the invention that together with the description serve to explain the principles of the invention.

In the drawings:

FIG. 1 is a cross-sectional, exploded view of an organic/inorganic composite in accordance with the present invention;

FIG. 2 is a flow diagram showing some of the numerous different types of laminate systems that can be made according to the present invention;

FIG. 3 is a cross-sectional view of a high temperature resistant, thermal shock resistant, and quench distortion resistant laminate according to the present invention containing a reinforcing core layer;

FIG. 4 is a cross-sectional view taken on line AA of FIG. 3.

FIG. 5 is a plan view of a laminate of the present invention prior to quenching wherein L is the length of the laminate and wherein above the length is a top plan view of the laminate wherein W is the width of the laminate; and

FIG. 6 is a side view of the laminate after heating to a high temperature and quenched wherein H is the height of the gap created by quenching.

### DETAILED DESCRIPTION OF THE INVENTION

The present invention relates to a heat distortion resistant laminate. One desired aspect relates to a light-weight, impact resistant, and high-temperature resistant laminate that has low steepness index (distortion) values upon rapid quenching as in ambient temperature water from a high temperature such as at least about 400° C. or at least about 700° C., or about at least 1,000° C.

An important aspect of the present invention is the utilization of at least one thermal resistant layer of the system or laminate that contains an inorganic polymer matrix composition in combination with generally a reinforcing, or structural layer.

The inorganic polymer matrix composition of the present invention is prepared by reacting an alkali silicate or alkali silicate precursors, a non-silicate network former such as an acidic oxoanionic compound, optionally a reactive acidic glass, water, and optionally one or more secondary network-linking units such as multivalent cation(s) selected from Groups 2, 3, 4, 5, 6, 7, 8, 9, 10, 11, 12, 13, 14, 15 or 16 of the Periodic Table such as alkaline earth salt and optionally one or more fillers. Alternately, the reaction of an alkali silicate or alkali silicate precursors, a reactive acidic glass, water, and optionally, one or more network modifiers, and/or one or more filler(s), can yield a high-temperature inorganic polymer matrix composition. Additional components such as functional and/or nonfunctional fillers, other network forming materials and modifiers can be incorporated as needed or desired.

The modified alkali silicate composition that is obtained can be cured at relatively low temperatures (<200° C.), and at low pressures (<200 psi) to produce an inorganic polymer network having dimensional and thermal stability to 1000° C. and higher. That is, a structure incorporating a matrix composition of the present invention exhibits no substantial permanent dimensional change at temperatures to 700° C. and higher. However, it is not restricted to the lower temperature or pressure, and if needed, or desired, properties can be further enhanced utilizing elevated processing temperatures (up to 1000° C. and higher) and pressures (up to 20,000+ psi), and/or incorporating post-cure heat treatments.

An approximate chemical composition of the invention, that is a qualitative representation of the starting materials, which is derived from the aqueous mixture before curing to form the inorganic matrix, can be described as follows:
(1−n)(aA₂O:SiO₂:bB:cC:dDₓ)•nH₂O Formula I

Where:

A=(1−z)K₂O or (z)Na₂O, where z can vary between 0 and 1, K₂O is potassium oxide, and Na₂O is sodium oxide, Li₂O and/or an equivalent such as LiOH can also be incorporated, if desired.

SiO₂ is silica, which can be derived from a silica source such as Kasil-1, silica fume, silica, silica gel or a combination thereof,

H₂O is water,

a=molar ratio of A₂O:SiO₂, which ranges from 0.05 to 1.0,

b=molar ratio of B:SiO₂, which ranges from 0.001 to 0.500,

c=molar ratio of C:SiO₂, which ranges from 0.0 to 0.250,

d=is the molar ratio of D:SiO₂ and ranges from 0.0 to 2.000,

n=molar ratio of H₂O incorporated into the formulation, for which during initial formulation, the desired range is from 0.10 to 0.90, with n=0.15 to 0.35 being preferred; and after cure, n is less than 0.25, with n<0.05 being preferred,

x=is the number of additives (D) used to aid in processing and performance of the basic formulation and ranges from about 0 to about 20,

B=non-silicate network formers, such as phosphate, sulfate, or borate groups, derived from an acidic precursor, such as H₃PO₄, H₂SO₄, H₃BO₃, a combination thereof and/or a reactive glass such as an alkaliborophosphate or an alkali phosphoborate glass.

C=network modifiers such as Mg²⁺, Ca²⁺, Zn²⁺, Al³⁺, Ti⁴⁺ derived from multivalent main group metal and/or transition metal compounds such as Mg(NO₃)₂, ZnCl₂, or a combination thereof or as a metallic component of a reactive glass, and

D=optional additives selected from one or more, alone or in combination, of

(i) reactive and/or non-reactive fillers such as but not limited to kaolin, smectites, hormites, mica, vermiculite, metakaolin, metal oxides, or a combination thereof;

(ii) gelation modifiers such as an organic base (quinoline) and/or an organic acid (lactic acid);

(iii) a surface-active agents such as an anionic, cationic and/or nonionic surfactant such as but not limited to alkylaryl sulfonates, quaternary ammonium salts, protonated organoamine salts, organic-inorganic hybrids such as silicones or combinations thereof; and

(iv) organic-based toughening and/or plasticizing agents which can be in the form of resin, low molecular weight and/or high molecular weight polymers.

An alternate expression of the chemical composition of the invention incorporating a reactive acidic glass can be also described as follows:
(1−n)(aA₂O:SiO₂:gG:fFₓ)•nH₂O Formula 2

where:

A=(1−z) K₂O or (z) Na₂O, wherein z can vary between 0 and 1, K₂O=potassium oxide, Na₂O=sodium oxide, Li₂O and/or an equivalent such as LiOH can also be incorporated, if desired,

SiO₂=silica, derived from a silica source such as Kasil-1, silica fume, silica, quartz or silica gel, or a combination thereof,

G=a reactive glass such as an alkaliborophosphate or an alkaliphosphoborate glass,

Fₓ=optional additives and/or nonsilicate network former(s), such as one or more, alone or in combination, of the following:

(i) P₂O₅, B₂O₃, or SO₃, derived from acidic precursors such as H₃PO₄, H₃BO₃ or H₂SO₄, or combinations thereof,

(ii) network modifier(s) such as Mg²⁺, Zn²⁺, Al³⁺, Ti⁴⁺ derived from multivalent main group metal and/or transition metal compounds such as Mg(NO₃)₂, ZnCl₂, or a combination thereof,

(iii) reactive and/or non-reactive fillers such as kaolin, spinels, smectites, hormites, mica, vermiculite, metakaolin, metal oxides, metal carbides or combinations thereof,

(iv) gelation modifiers such as an organic base (quinoline) and/or an organic acid (lactic acid),

(v) surface-active agents such as an anionic, cationic and/or nonionic surfactant such as but not limited to alkylaryl sulfonates, quaternary ammonium salts, protonated organoamine salts, organic-inorganic hybrids such as silicones or combinations thereof,

(vi) organic-based toughening and/or plasticizing agents which can be in the form of resins, low molecular weight and/or high molecular weight polymers.

H₂O=water,

a=molar ratio of A₂O:SiO₂, which ranges from 0.05 to 1.00,

g=molar ration of G:SiO₂, which ranges from 0.01 to 0.500,

f=molar ration of F:SiO₂, which ranges from 0.000 to 2.000,

x=0 to about 20 and represents the number of additives (F) used to aid in processing and performance of the basic formulation, and

n=molar ratio of H₂O incorporated into the formulation, where during initial formulation, the range is from 0.10 to 0.90, with n=0.15 to 0.35 being the preferred embodiment, and after cure, n is less than 0.25 with n<0.05 being preferred.

Processing aids can also be added, if needed, and include mineral oils, vegetable oils, animal oils, silicone oils, fatty acids and salts, aliphatic alcohols, fluorinated oils, waxes, polyolefins (such as for example but not limited to polyethylene, oxidized polyethylene, and polytetrafluoroethylene), graphites, surfactants or combinations thereof.

The alkali silicates utilized in this invention can include a wide range of silica/alkali oxide (SiO₂/A₂O) ratios and % solid levels. Such solutions can be purchased from commercial sources or prepared immediately prior to use from precursors such as a silica source and an alkali hydroxide, alkali oxide, carbonate or combinations thereof. The alkali silicate can be derived from an alkali base, such as potassium hydroxide or sodium hydroxide, from potash or soda ash and a silica source. The SiO₂ source can be an amorphous or crystalline SiO₂, such as silica, silica fume, precipitated silica, fumed silica, microsilica, sand, microcrystalline silica, silica gels, colloidal silica, quartz, quartz flour, a sodium silicate solution, a potassium silicate solution as well as solid sodium and/or potassium silicates. An example of a commercially available alkali silicate is Kasil-1, available from PQ Corporation, Valley Forge, Pa. Various silica sources exhibit desired as well as undesired attributes. For example, some silica fume sources contain traces of carbon that can lead to discoloration in the final product. In addition, the thermal and physical properties of the inorganic polymer matrix composition can be influenced by the nature of the silica source, for example, the incorporation of a dense crystalline α-quartz network can enhance dimensional stability while, in turn, introducing an open, amorphous silica source will produce a lower density network. However, an appropriate alkali silicate solution can be achieved by a combination of various sources of alkali and/or silica. When the alkali silicate is derived from an alkali hydroxide and a silica source, the alkali hydroxide is present in an amount of about 3 wt. % to about 30 wt. % based upon the weight of the total composition or mixture, preferably about 7 wt. % to about 20 wt. %. The silica source is present in an amount of about 10 wt. % to about 85 wt. % or about 90 wt. % or about 94 wt. %, preferably 15 wt. % to 70 wt. %. In some cases, for example, when an alkali silicate solution is used, a portion of the alkali hydroxide, silica and water provided is included in the ranges disclosed.

The alkali silicate used in the preparation of the inorganic resin composition is potassium silicate solutions, sodium silicate solutions, crystalline sodium silicate, crystalline potassium silicate, amorphous sodium silicate, amorphous potassium silicate, lithium silicate, and mixtures thereof. Alternatively, the alkali silicate precursors are an alkali base and a silica source. The silica in the alkali silicate is an amorphous or crystalline silica form, selected from the group consisting of silica, silica fume, microsilica, precipitated silica, sand, quartz, quartz flour, silica gels, fumed silica and colloidal silica. Preferably, the alkali silicate and/or alkali silicate precursors has a SiO₂/A₂O ratio of about 2.0:1.0 to 20.0:1.0, where A is K (potassium) and/or Na (sodium), and wherein the alkali hydroxide is selected from the group consisting of potassium hydroxide and sodium hydroxide.

Non-silicate network formers can be introduced if desired in the range of about 2 wt % to 70 wt %. A non-silicate network former can be added as an acidic oxoanionic compound. Examples of acidic oxoanionic compounds include boric acid, phosphoric acid, sulfuric acid, sodium dihydrogen phosphate, disodium hydrogen phosphate, dipotassium hydrogen phosphate, potassium dihydrogen phosphate, ammonium hydrogen phosphate, metallic and/or nonmetallic phosphate salts, or compounds incorporating borate, sulfate, aluminate, vanadate, germinate, and the like ions and combinations or mixtures thereof and optionally includes at least one phosphorus compound. A non-silicate network former can also be added as a non-acidic oxoanionic compound such as trisodium phosphate, potassium phosphate, sodium borate or similar salts of acids if the pH of the mixture is adjusted by other means. The preferred mixture of acidic oxoanionic compounds include mixtures of potassium dihydrogen phosphate and boric acid; sodium dihydrogen phosphate and boric acid; potassium dihydrogen phosphate, sodium dihydrogen phosphate and boric acid; sodium borate and potassium dihydrogen phosphate, which can be used in any grade or concentration although a more concentrated material is preferred to minimize the water content. The acidic oxoanionic compound is present in an amount of between about 0.01 wt. % and 20 wt. % based upon the total composition. The preferred amount of acidic oxoanionic compound is between about 2 wt. % to about 8 wt. %. Compounds that incorporate multivalent atoms and acidic oxoanions can also be incorporated. Examples include monoaluminum phosphate (Al(H₂PO₄)₃, aluminum metaphosphate (Al(PO₃)₃, monobasic magnesium phosphate, magnesium hydrogen phosphate, zinc dihydrogen phosphate, monocalcium phosphate, calcium hydrogen phosphate, monobasic barium phosphate, dibasic barium phosphate, manganese dihydrogen phosphate, manganese hydrogen phosphate and similar metal phosphates.

Alternatively, a reactive acidic glass can be used in conjunction with the alkali silicate solution to form the composition. The phrase “reactive acidic glass” encompasses a wide variety of acidic inorganic glasses that can contribute an acid group in the condensation reaction between the alkali silicate and the glass that occurs during the curing step. Reactive acidic glasses are preferred, and examples of reactive acidic glasses include borophosphosilicate, phosphate, phosphoborate, borophosphate and borate glasses. There may be reactive glasses which are not truly acidic, but which function in the same manner. A non-acidic glass (pH about 7 to about 10) can be used provided the pH of the reactive glass is less than that of the pH of the alkali silicate component and/or its precursors. Elevated processing conditions may be necessary to consolidate such a composition including higher temperatures (>200° C.) and/or higher pressures (>200 psi). Reactive glasses are different from essentially nonreactive structural glasses as used in beakers and drinking vessels, and optical glasses as used in windows. Reactive glasses are made according to typical glassmaking processes by combining oxide reactants. In the case of an alkali borophosphate glass, P₂O₅, B₂O₃, and one or more alkali oxides or their precursors are combined in a powder form and heating the mixture to its fusion temperature of about 700° C. to about 1500° C. and then rapidly cooling the melt and optionally annealing the glass to a rigid, friable state. The ratio of phosphoric oxide to alkali metal oxide (A₂O) will be about 6.1:1.0 to 1.5:1.0.

Preferably, the glass solid is pulverized to form a powder. Reactive borophosphate glass powder is the preferred powder. The use of this preferred glass powder facilitates control of the cure rate and the amorphous nature of the matrix. The thermal and physical properties of the inorganic silicate/glass matrix can be varied by adjusting the ratio of SiO₂ to the reactive glass and/or glass precursors (G). The G:SiO₂ ratio can vary from 0.01 to 50.0 by weight. The reactive glass is used in an amount of between about 0.01% to 60% by weight of the total mixture, with 3% to 35% being preferred, and 5% to 20% by weight being the most preferred.

Since it is desired that the glass formed is acidic, the composition of the glass will consist primarily of the glass formers such as the oxides of phosphorus, boron and optionally silicon. The preferred alkali oxide is lithium oxide. If a high phosphorus glass is needed, the glass composition before fusion will comprise about 20 mol % to about 80 mol % of phosphorus pentoxide (P₂O₅), or its salts, acids, or other precursor forms, which provide the right or equivalent amounts of phosphorous and oxygen based upon the total glass formulation, preferably 30 mol % to 70 mol %, with 35 mol % to 65 mol % being further preferred. Most preferably, 60 mol % to 65 mol % is used. The boron oxide (B₂O₃) will comprise about 1 mol % to 15 mol % of the glass, with 2 mol % to 8 mol % being preferred and 4 mol % to 6 mol % further preferred. The alkali oxide (A₂O) comprises about 5 mol % to 50 mol % of the glass composition, with 20 mol % to 40 mol % being preferred, and 15 mol % to 30 mol % further preferred. The alkaline earth oxide (M′O) is used in an amount of between about 0.01 mol % to 30 mol % of the total glass mixture, with 5 mol % to 20 mol % being preferred, and 10 mol % to 15 mol % being further preferred. Other oxides can be incorporated as desired, such as including but to limited to aluminum oxide, iron oxide, lanthanum oxide, cerium oxide, molybdenum oxide and silicon dioxide. These oxides are added at up to 20 mol %.

If a high boron glass is needed, the glass composition before fusion will comprise about 10 mol % to about 50 mol % of phosphorus pentoxide (P₂O₅), or its salts, acids, or other precursor forms, which provide an equivalent amounts of phosphorus and oxygen based upon the total glass formulation, preferably 20 mol % to 40 mol %, with 25 mol % to 35 mol % being further preferred. The boron oxide (B₂O₃) will comprise about 10 mol % to 70 mol % of the glass, with 30 mol % to 60 mol % being preferred and 45 mol % to 55 mol % further preferred. The alkali oxide (A₂O) comprises about 5 mol % to 45 mol % of the glass composition, with 20 mol % to 40 mol % being preferred, and 15 mol % to 30 mol % further preferred. The alkaline earth oxide (M′O) is used optionally in an amount of between about 0 mol % to 30 mol % of the total glass mixture, with 5 mol % to 20 mol % being preferred, and 10 mol % to 15 mol % being further preferred if used.

The formulation of the reactive glass, if used, is critical to the chemistry and the performance of this invention. It is desired that the glass react with the alkali silicate mixture to reduce the basicity of the resulting matrix and to conjoin multiple networks. The combination of very different networks, one silicate-based and the other phosphate-based results in a blend of an amorphous inorganic polymer and a crystalline network as well as new network units formed by reaction of the basic silicate and the acidic phosphate such as —Si—O—P—. Both silicate and phosphate species are known to be excellent network formers form the basis for this invention.

The reactive glass that can be used to form the composite can be concisely described by the following formula:
ⁿχ((M^{p+})_{q′})(E^{q-})_{p′})ᵣ_{ₖ} where Σrₖ=1
k−1 Formula 3

where:

n=number of desired glass components,

M=at least one glass former, such as boron, silicon, phosphorus, sulfur, germanium, arsenic, antimony, aluminum, and vanadium, and at least one glass modifier which functions as a flux, such as lithium, sodium, potassium, rubidium and cesium, and, optionally, additional network modifiers such as vanadium, aluminum, tin, titanium, chromium, manganese, iron, cobalt, nickel, copper, mercury, zinc, thulium, lead, zirconium, lanthanum, cerium, praseodymium, neodymium, samarium, europium, gadolinium, terbium, dysprosium, holmium, erbium, thulium, ytterbium, actinium, thorium, uranium, yttrium, gallium, magnesium, calcium, strontium, barium, tin, bismuth, and cadmium,

E=oxygen, chalcogenides and/or halogens such as sulfur, selenium, tellurium and fluorine,

p=cation valence of M, such as 5 for phosphorus, which is generally portrayed as p⁵⁺ or P(V),

q=anion valence of E such as 2 for oxygen, which is generally portrayed as O²⁻,

q′=number of M cations contained in a network unit equal to q or ^{q}/₂ whichever is the lesser whole number whenever p and q are even numbers, such as 2 for phosphorus in P₂O₅ or 1 for silicon in SiO₂,

p′=number of E anions contained in a network unit equal to p or ^{p}/₂ whichever is the lesser whole number whenever p and q are even numbers, such as 5 for phosphorus in P₂O₅ or 2 for silicon in SiO₂,

r=molar fraction of each individual network unit in the reactive glass component,

n=number of total network units in the reactive glass component.

A binary glass can be represented by {(M₁^{p+})_{q′})(E₁^{q-})_{p′}}ᵣ₁{(M₂^{p+})_{q′})(E₂^{q-})_{p′}}ᵣ₂, r₁+r₂=1 and a ternary glass can be generalized as {(M₁^{p+})_{q′})(E₁^{q-})_{p′}}ᵣ₁{(M₂^{p+})_{q′})(E₂^{q-})_{p′}}ᵣ₂{(M₃^{p+})_{q′})(E₃^{q-})_{p′}}ᵣ₃, r₁+r₂+r₃=1. Thus a soda-lime glass can be described as (CaO)ᵣ₁(SiO₂)ᵣ₂(Na₂O)ᵣ₃ where r₁+r₂+r₃=1. Silicon (Si) is a glass former covalently bound to oxygen to yield the glass network and sodium (Na) and calcium (Ca) are glass modifiers that bond ionically to the silicate network aiding in the formation and durability of the glassy phase. Therefore, M generically represents at least one glass network former (M_{gf}) and at least one glass network modifier (M_{gm}) in the glass recipe.

The reactive glass desirably can be generalized by the following formula:
a(A′₂O)ₓb(G_{f}O)_{y}c(A″O)_{z},
where A′ represents at least one alkali metal glass modifier, which function as fluxing agents, such as lithium, sodium, potassium, rubidium and cesium, G_{f} represents at least one glass former, such as boron, silicon, phosphorus, sulfur, germanium, arsenic, antimony, aluminum, and vanadium, A″ represents, optionally, at least one glass network modifier, such as vanadium, aluminum, tin, titanium, chromium, manganese, iron, cobalt, nickel, copper, mercury, zinc, thulium, lead, zirconium, lanthanum, cerium, praseodymium, neodymium, samarium, europium, gadolinium, terbium, dysprosium, holmium, erbium, thulium, ytterbium, actinium, thorium, uranium, yttrium, gallium, magnesium, calcium, strontium, barium, tin, bismuth, and cadmium, a represents the number of fluxing agents present and can range from 1 to 5, b represents the number of glass formers present and can range from 1 to 10, c represents the number of glass network modifiers and can range from 0 to about 30, x represents the mole fraction of fluxing agent and is between about 0.050 and about 0.150, y represents the mole fraction of glass former and is between about 0.200 and about 0.950, z represents the mole fraction of glass network modifiers and is between about 0.001 and about 0.500, x+y+z=1, and x<y.

The refining time and temperature of the glass also influences its physical and mechanical characteristics. For a constant composition increasing the refining temperature and/or time further densifies the glass network raising the T_{g}, Tₛ and Tₘ, reducing network activity and the hydroxyl/H₂O content of the glass while enhancing durability. Thus by varying the glass composition, the glass refining time and temperature, various glass formulations can differ greatly with regard to reactivity, durability, acidity, hydrolytic stability, toughness and processing. Modest levels of silica and/or alumina may be optionally added to limit furnace contamination and/or strengthen the glass network if needed for very high temperature resistance (>900° C.). The matching, blending and adjustment of the glass and the alkali silicate properties allows the formulation of a high-temperature material with unique and novel properties. In other words, the ability to vary these “building blocks” enables one to tailor product properties to suit numerous high-temperature applications.

The particle size of the reactive glass, as is the particle size of the additional ingredients, is important, but not critical. Obviously, reactivity of the ingredients increase as the particle size decreases and if the particles are too fine then the materials may be too reactive, thus adjustments may be needed to be made in the components employed to make the compositions of the present invention. The powder components of the composition (silica, reactive glass, etc.) can be prilled, granulated, pelletized or otherwise compacted prior to addition to the liquid portion of the composition.

Although an aspect of the invention is the inorganic polymer matrix composition resulting from the reaction of the alkali silica source and the a non-silicate network former and/or reactive glass, the mechanical, the physical and processing characteristics of the matrix can be enhanced by the additional components as desired. Additional components such as fillers, other network forming materials and modifiers can be incorporated as needed. These include additives, network formers, and fillers typically used or known to ones skilled in the art, whether inorganic, organic or hybrid, and can include additives or fillers to permit processing, fabrication and enhanced performance in service.

The secondary network-linking units can be multivalent cations which are used will be selected from Groups 2, 3, 4, 5, 6, 7, 8, 9, 10, 11, 12, 13, 14, 15 and 16, preferably from Groups 2, 3, 4, 5, 11, 12, 13, 14, 15 and 16 of the Periodic Table and are used in an amount of between zero and about 20 wt. % based upon the total mixture, with the ranges of about 1.0 wt. % to about 5 wt. % is preferred. Multivalent cations Cr, Mo, W, Mn, Fe, Co, Ni, Pd, and Pt of the Groups 6, 7, 8, 9, and 10, also can be used, but ones from the other Groups are preferred. The multivalent cation containing compounds can comprise any main group metal salt including nitrates, sulfates and chlorides, although salts of zinc, magnesium and calcium are preferred. The optional secondary network-linking unit can be a multivalent cation useful for coordinating with oxo species such as the alkaline earths, main group metals, transition metal species, lanthanides and/or actinides and any useful combination thereof. Other secondary network-linking units can include compounds incorporating boron, aluminum, lead, gallium, cadmium, titanium, zirconium, lanthanum, cerium, neodymium, yttrium, strontium, barium, lithium, rubidium, cesium, and fluorine.

The optional additives that can be used include clay fillers, oxide fillers, gel modifiers, organic toughening agents, plasticizing agents or combinations thereof. Fillers include kaolin, metakaolin, montmorillonites, mica as well as other smectites and other clay or mineral fillers. When clay fillers are employed, calcined kaolin is preferred, and can be used in an amount from zero to 25 wt. % based upon the weight of the total composition, with 3 wt. % to 5 wt. % being preferred. The calcined kaolin may have some reactivity with the silicate matrix material, although reactivity of the clay filler is not required, and any of the commercially available clay fillers can be employed.

The optional oxide fillers that could be employed include oxides of boron, aluminum, silicon, zinc, gallium, titanium, zirconium, manganese, iron, molybdenum, tungsten, bismuth, lead, lanthanum, cerium, neodymium, yttrium, calcium, magnesium and barium and is present in an amount of between about 0.0 wt. % and about 20 wt. % based upon the total composition weight. Magnesium oxide (MgO, which is preferred) and is used in an amount of zero % to 15% by weight based upon the total weight of the composition, with 1% to 10% by weight being preferred and 2% to 8% by weight being further preferred.

Modifiers can include crosslinkers and gel inhibitors or promoters such as mineral acids, organic acids and bases. Crosslinkers can also be introduced as metal phosphates as described earlier. These include aluminum phosphate, magnesium phosphate, calcium phosphate, zinc phosphate, iron phosphate, cerium phosphate, lanthanum phosphate, barium phosphate, monoaluminum phosphate (Al(H₂PO₄)₃), aluminum metaphosphate (Al(PO₃)₃), monobasic magnesium phosphate, magnesium hydrogen phosphate, zinc dihydrogen phosphate, monocalcium phosphate, calcium hydrogen phosphate, monobasic barium phosphate, dibasic barium phosphate, manganese dihydrogen phosphate, manganese hydrogen phosphate and similar metal phosphates.

The optional gel modifier is an organic acid and/or organic base generally selected from the group consisting of hydroxyacids and N-based and P-based bases. Examples of organic acids include lactic acid and citric acid. Preferably α-hydroxyacids, β-hydroxyacids, substituted pyridines and quinolines are used. These are utilized in an amount from none to 10 wt. % based upon the weight of the total composition, with 0.05 wt. % to 5 wt. % being preferred. The optional surface-active agent is an anionic, cationic and/or a nonionic surfactant such as but not limited to alkylaryl sulfonates, silicones, quaternary ammonium salts, protonated organoamine salts, hydroxyl polymers, organic-inorganic hybrids such as silicones or combinations thereof. These additives are utilized in an amount from none to 10 wt. % based upon the weight of the total composition, with 0.5 wt. % to 5 wt. % being preferred.

The optional organic toughening agent and/or plasticizing agent is an organic-based toughening agent, plasticizing agent, or combinations thereof. The organic based toughening agents can be chosen from the group consisting of resins, low molecular weight and/or high molecular weight polymers. These are utilized in an amount from none to 10 wt. % based upon the weight of the total composition.

The balance of the uncured composition is water and it will comprise about 10 wt. % to about 75 wt. % based upon the total composition weight. The range of 15 wt. % to 40 wt. % is preferred. The water can be introduced as part of one of the components, such as part of an alkali silicate solution, an alkaline earth salt solution or part of a phosphoric acid solution. Since the water incorporated in this invention can be viewed as a reaction medium, a reactant as well as a reaction product, the concentration of water can be difficult to quantify in general. The initial level of water in the starting mixture can vary from about 10 wt. % to about 70 wt. % while a B-staged prepreg may contain about 5 wt. % to about 35 wt. % water. A cured sample of the inorganic binder by itself as well as the composite can contain about 0 wt. % to about 10 wt. % water depending upon the processing conditions.

As noted above, a very important aspect of the present invention is the desirable use of a reinforcing medium desirably of woven and/or non-woven, continuous and/or discontinuous fibers, which are utilized in the alkali silicate resin layer to generally form a composite layer or structure. Reinforcement can range from about 2 vol. % to about 60 vol. %. Reinforcing fibers may include mineral or organic fibers such as nickel fibers, glass fibers, carbon fibers, graphite fibers, mineral fibers, oxidized carbon fibers, oxidized graphite fibers, steel fibers, metallic fibers, metal-coated carbon fibers, metal-coated glass fibers, metal-coated graphite fibers, metal-coated ceramic fibers, nickel-coated graphite fibers, nickel-coated carbon fibers, nickel-coated glass fibers, quartz fibers, ceramic fibers, aluminosilicate fibers, silicon carbide fibers, silicon oxycarbide fibers, stainless steel fibers, titanium fibers, nickel alloy fibers, brass-coated steel fibers, polymeric fibers, polymer-coated carbon fibers, polymer-coated graphite fibers, polymer coated glass fibers, polymer-coated aramid fibers such as Kevlar®, ceramic-coated carbon fibers, ceramic-coated graphite fibers, ceramic-coated glass fibers, oxidized polyacrylonitrile fibers, basalt fibers, alkaline resistant glass fibers, SiC fibers, BN fibers, and/or other fibers known to those knowledgeable in the arts. Combinations of these various fibers can also be used. Preferably, the fibers are graphite fibers, E-glass fibers, S-glass fibers, basalt fibers, stainless steel fibers, titanium fibers, nickel alloy fibers, aramid fibers, SiC fibers and BN fibers. These fibers can also be coated and/or treated. Examples of suitable coatings to be used on the fibers include vapor deposited metal and metal alloys, chemically deposited metal and metal alloys, metals and metal alloys applied in a molten state, electrolytically applied metals and metal alloys, organic polymer coatings, inorganic-organic polymer hybrid coatings, metal oxides, phosphates, metal phosphates, silicates, organic polymer-silicate and organic polymer-silica hybrids and functionalized siloxanes.

Reinforcing fibers may be in many forms, including yarns, tows, whiskers, continuous fibers, short fibers, woven fabrics, woven sheets, knitted fabrics, non-woven fabrics, random mats, needled mats, screens, felts, braided fabrics, wound tows, wire and/or other forms known to those knowledgeable in the arts.

Glass fiber reinforcement (including for example but not limited to E-glass fibers, S-glass fibers, or alkali resistant glass fibers) can be used as a reinforcing material. The composite layers or structures can also incorporate hybrid fiber reinforcements such as combinations of glass, carbon, organic polymer, oxide and/or metal fibers. The reinforcement can be in the form of woven or non-woven fabric, mesh, screen, wool, continuous or non-continuous fibers. The different fibers and/or fabrics can be commingled throughout the matrix or discretely separated into layers. Examples include alternating layers of carbon and glass fiber reinforcement as well as steel screen sandwiched between glass veils. The composite layers using glass fiber reinforcement and the matrix binder of the present invention are affordable, non-combustible, thermally-stable for example, no measurable (<0.2%) permanent dimensional change after 48 hours of exposure at 700° C., composite materials with insulating qualities and structural qualities that can be processed at lower temperatures using typical processing equipment. Normal processing can be at relatively low temperatures (<200° C.) and low pressure (<200 psi). A cross-ply glass fiber laminate can be produced with thermal insulating qualities (for example, thermal conductivity of nominally 1.4 W/m-K), electrical insulating qualities (no detectable electrical conductivity when measured with a standard ohm meter) and modest mechanical performance (flexural modulus up to 18 Msi, flexural strength to 200+ ksi, and ultimate flexural strains up to 1.3%). This combination of properties should be enabling technology for many applications.

Ceramic fiber reinforcement (including silicon carbide fibers) is another preferred reinforcement, especially for high temperature applications above 700° C. Although expensive, ceramic fibers maintain structural integrity well above 1,000° C. Carbon fiber reinforcement is a preferred reinforcement where electrical conductivity, thermal conductivity, high strength and/or impact resistance is desired.

The mechanical properties of the inorganic polymer matrix composition (OMIT) incorporating the inorganic polymer matrix composition can be enhanced provided there is sufficient interaction between the matrix and the reinforcement. A composite structure incorporating the inorganic polymer matrix composition provides an enhanced level of mechanical strength if the reinforcement exhibits some degree of oxophilic character at the matrix-reinforcement interface. A composite structure comprising the inorganic polymer matrix composition and stainless steel reinforcement exhibits an enhanced level of mechanical performance. The improvement is better illustrated when using a carbon or graphite fiber as reinforcement. Carbon and/or graphite fibers are inherently nonpolar and hydrophobic but can be treated in a variety of ways to develop regions of hydrophilic character such as the application of sizing or other coatings (generally organic polymers such as epoxies or organosilanes) or through the use of surfactants. Generally enhancing the hydrophilic nature of fiber will also create a more oxophilic surface and improve the interface between the reinforcement and the matrix but the reinforcement can be made more oxophilic by other means. Metallization of the fiber can develop an oxophilic surface that will significantly enhance the interfacial strength of the composite structure. Chemical, thermal and electrolytic oxidation of carbon, graphite and/or polymeric reinforcements can also enhance oxophilicity and thus the interfacial strength and mechanical properties of the composite structure. Furthermore, the fiber can be sized with an organic polymer combined with an inorganic oxide particulate such as a glass frit, reactive glass frit, silica, alumina, zirconia and similar oxide-based materials. This imparts an oxophilic character to the surface of the reinforcement. These concepts can extend also to other oxo-based matrix compositions including but not limited to alkali silicate resins, metal phosphate resins, cementitious materials, refractory compounds and other oxide-based inorganic and/or inorganic/organic hybrid materials. Ensuring that the surface of the reinforcement media has sufficient irregularity or roughness to promote a beneficial mechanical interaction can also enhance the interface between the matrix and the reinforcement.

In addition, the inorganic polymer matrix compositions may incorporate a wide variety of organic and inorganic fillers commonly used by those knowledgeable in the art. The matrix may incorporate filler materials such as ceramic powders, mineral powders, metallic powders, silicon carbides, silicon nitrides, silicates, boron nitrides, aluminosilicates, aluminum silicates, sodium aluminum silicates, potassium aluminum silicates, carbon, carbon black, carbon nanotubes, molybdenum and its compounds, or other fillers known to those knowledgeable in the arts. Organic materials are less preferred where the application is such that the organic materials will combust and produce gases. The filler materials also could be spheres such as microspheres, macrospheres, hollow and/or solid spheres, and/or cylindrical, flat and/or irregular or non-irregular shaped particles.

The inorganic polymer matrix composition of the present invention influences the pH of the solution containing the alkali silicate backbone by incorporating an acidic inorganic component (such as a protonated oxoanions such as phosphoric or boric acid, dihydrogen phosphate or reactive glasses) and acidic salt modifier such as an alkaline earth salt. The alkali silicate solutions require a high pH to maintain a high concentration of monomeric silicate anions needed to moderate network formation. The ability to cure under moderate conditions after reducing the pH to a lesser value reduces the damage to the glass fiber reinforcement induced by the alkalinity of the matrix. The inorganic matrix binder cures via a condensation reaction partially driven by the elimination of water from the framework and excessive water in the binder leads to a lack of dimensional stability, poor physical properties and difficulty in processing.

As can be appreciated, the inorganic polymer matrix compositions and/or composites of the present invention can be fabricated and processed into composites using compression molding, bulk molding compound, sheet molding compound, powder and reinforcement, liquid and reinforcement, prepreg and sintering. Additional methods include pultrusion (an automated process capable of producing a constant cross-section product), wet lay-up (a simple manual process for rapid prototypes and affordable low performance products), filament winding (an automated process for bodies of revolution), vacuum bag processing (a typical process for high performance aerospace laminates), autoclave or non-autoclave, vacuum infusion (a process for large thick high-performance parts), liquid resin, film infusion or powder infusion, resin transfer molding (a near net-shape molding process with excellent dimensional repeatability), extrusion (a process capable of producing constant cross-section non-structural short-fiber products), injection molding (an automated process capable of producing small non-structural short-fiber products), casting (a process for bulk non-structural products), spin casting (a process capable of producing high-quality tubing), trapped elastomer molding (a process capable of producing unusual shapes), and like processes.

The composition and/or composite is cured within a temperature range of about 15° C. to about 1000° C. and higher, and a pressure range from 0 psi to about 2000 psi, preferably at a temperature between about 50° C. to about 200° C. and at a pressure less than about 200 psi.

If desired, the composition and/or composite part can be thermally post-cured and/or chemically treated to further enhance thermal, dimensional or hydrolytic stability or combinations thereof. The part can be thermally treated in air, in vacuo or in an inert atmosphere within a temperature range of about 15° C. to about 1000° C. The part can be washed with water or other solvent to remove excess reactants. Furthermore, this can be done after only partial formation of the inorganic polymer network prior to completion of the curing process. The part can also be contacted with acid solutions, metal salt solutions, metal acid salt solutions, surfactant solutions, solutions of fluorinated compounds, silicon-based compounds, organic prepolymers, ionomers, polymers and/or other solutions intended to impart hydrophobicity.

For example, immersion or coating of a composition and/or composite structure with a dilute solution of phosphoric acid can enhance both the thermal as well as the hydrolytic stability of the composite structure. The phosphoric acid may be in solution with one or more metallic salts. Similar improvement can be achieved using a dilute solution of a magnesium salt alone or in combination with the phosphoric acid solution. Other soluble polyvalent metallic salts such as those containing aluminum, calcium, zinc, cerium, lanthanum and/or similar salts can be used also. Solutions of monovalent metallic salts such as lithium hydroxide, lithium acetate, lithium chloride and so forth can also be contacted with the structure if desired.

These processes have several advantages compared to the curing/consolidation methods normally used in making high temperature inorganic polymers, namely ceramics and glasses. Ceramic and glass processing typically requires high temperature processing equipment (above 1000° C.). The nature of the inorganic matrix formulation of the present invention allows compositions and/or composites to be processed with conventional equipment found in composite manufacturing facilities. These processes allow a more rapid throughput than typical ceramic processes and enable the easy manufacturing of larger parts than typical ceramic processes. The use of these processes allows high fiber volumes for structural integrity, which is superior to regular concrete processing.

As can be appreciated, the present invention can be formulated to be non-combustible. This desirable safety feature differentiates the invention from most organic materials (such as for example but not limited to plastics, wood, or rubber) that tend to combust, generate smoke and/or toxic gases upon exposure to fire. Further, the present invention can be formulated to be a thermal insulator and/or an electrical insulator. This desirable feature differentiates compositions in accordance with the present invention from most metals (such as steel, aluminum, or copper) that tend to be thermal and electrical conductors.

The alkali silicate inorganic resin layers of the present invention can be formulated to perform at high temperatures (>1,000° C.) with negligible permanent changes in dimensions. This desirable feature differentiates the invention from most organic materials (which tend to pyrolyze when exposed to temperatures above 500° C.), from most cement formulations (which tend to spall above 300° C.) and from many metals (including aluminum) that tend to warp or melt at 700° C. The alkali silicate inorganic resin layers of the present invention also have good thermal resistance, inasmuch as they don't degrade at temperatures of at least about 400° C. or about 500° C. or higher, desirably about 640° C. or about 700° C. or higher, and about 800° C., or about 900° C., or about 1,000° C. or higher. As a further feature, the present invention can achieve high temperature performance (up to and above 1,000° C.) while being processed at relatively low temperatures, (<200° C.) and low pressures (for example but not limited to <200° C. and <200 psi). This feature is desirable because the ability to process at low temperatures and pressures allows the invention to be processed with more affordable equipment and manufacturing processes. This feature of the chemistry differentiates the present invention from most ceramics, glasses and metals, which generally require very high temperatures and/or high pressures to create a molded shape. (Of course, the invention also can be effectively processed at higher temperatures and pressures; the material has been processed at pressures above 10,000 psi and at temperatures above 1500° C.).

In some instances, an application may require a thermal barrier to resist a flame and/or elevated temperatures for a single service cycle and then replaced or applications at reduced service temperatures, which do not need to withstand extreme temperatures greater than 200° C. An organic-inorganic hybrid based on the present invention may be useful. The organic component may be monomeric, oligomeric or polymeric in nature and imparts additional toughness, plasticity and flexibility to the hybrid composition.

The present invention can be formulated to impregnate fibers to form a rigid composite material. This desirable feature differentiates the invention from most materials, because most rigid materials have not been processed as a low viscosity liquid capable of wetting fibers. Fiber reinforcement within a matrix material offer many benefits, including improved strength, stiffness, fracture toughness, fatigue, strength, and impact resistance. While fiber-reinforced composite materials are common in applications ranging from automotive fascia to F-22 aircraft structures, the vast majority of composite materials are made with organic matrix materials, which are combustible. Non-combustible composite materials, such as ceramic matrix composite materials and metal matrix composite materials tend to be cost prohibitive for most applications because of the high processing temperatures required. The present invention can be processed at much lower cost than most ceramic or metal matrix composite materials. These desirable features differentiate the present invention from many materials, including numerous metals.

The present invention readily can be formulated to incorporate a wide variety of the generally above noted fillers to tailor the material performance to suit the specific application. These fillers that may include hollow spheres, conductive fillers, friction and/or thermal additives, can be incorporated to modify physical properties including but not limited to density, conductivity, coefficient of friction, or thermal performance. These desirable features differentiate the present invention from many materials, including many metals. Given these features, the present invention is suited for many applications, including fire barriers, heat shields, high-temperature insulators, high-temperature molds, friction products, tooling and structures in high temperature environments.

In addition to the inorganic polymer matrix compositions, may other compounds may be utilized such as various organic and inorganic fillers, and the inorganic polymer matrix compositions can be fabricated by utilizing various processes such as compression molding, bulk molding, etc., and subsequently cured and treated and used in a wide variety of applications and have desirable properties according to numerous ASTM tests, all as set forth in U.S. patent Ser. No. 10/777,885, filed Feb. 12, 2004, for Fire Testing Inorganic Composite Structures, hereby fully incorporated by reference including all 39 examples thereof.

### Thermal Barrier Systems

The thermal-barrier systems of the present invention generally comprise two or more layers of a different material with preferably at least one of the layers comprising the above noted inorganic polymer matrix derived from an alkali silicate, and optionally, but desirably containing a fiber reinforcement therein. The remaining one or more layers comprise any of the following: at least one insulating material, or at least one intumescent material, or at least one foam material, or at least one reflective material, or a reinforcement layer, or a reinforcement material in any of the above layers. Additionally, a corrugated gas containing layer can exist separately, or within any of the above layers. Still another thermal-barrier system comprises two or more layers of the alkali silicate polymer resin.

Insulation materials which have good thermal or fire-barrier properties generally include high temperature resistant materials known to the literature and to the art such as various silicate compounds, various alumina compounds, or combinations thereof such as alumina silicates, (RCF). Often such compounds are in the form of fibers since they are of low weight and have many applications but solid layers of the same can also be utilized. Other suitable insulation materials include various minerals or compounds known to the art and to the literature which generally contain high amounts, (at least about 30%, or about 50% or about 70% by weight) of alumina, silica, aluminate, silicate, as well as other metal oxides therein containing calcium, magnesium, and the like. Still other insulation compounds include various refractory type materials such as silicon carbide, carbon-carbon, and the like. Various ceramic materials known to the literature and to the art can also be utilized as made from various clays, for example tile, terra cotta, and the like, porcelain, porcelain enamels, lime, plaster, and gypsum products, and the like.

The intumescent layer is generally any material which evolves a volatile, e.g. water, during heating at a time when the material's structure will support cell formation. Exfoliated graphite being preferred. Other compounds include the various alkali silicates such as sodium, potassium, or lithium silicate, or alkaline earth silicates such as calcium or magnesium silicate. Vermiculite is another useful intumescent.

The reflective layers are naturally composed of materials which reflect light and thus radiate heat away from the non-heated or thermally non-impinged side of the system. The layer may be thick but preferably is thin and is made of a high-temperature resistant material. Suitable reflective materials generally reflect at least about 50%, or at least about 65%, and desirably at least about 80% or at least about 90% of sunlight incident thereon. Examples include polyester film such as Mylar®, aluminum foil or sheeting, and the like. Higher temperature resistant reflective surfaces generally include highly reflective metals and alloys such as titanium, chrome, nickel, and the like, stainless steel, and the like. The reflective surfaces are generally in sheet form and exist on the interior or the exterior of the laminate or multi-layer thermal barrier system.

Reinforcing materials have been described herein above and hence will not be repeated. While generally utilized in fiber form, either continuous our discontinuous, woven or non-woven, they can also be utilized in sheet form, or perforated sheet form, strips, and the like, and thus form an individual or separate layer. Desirably, as noted above, the reinforcing material is generally used in fiber form to reinforce the inorganic resin composite layer of the present invention. However, the various above-noted reinforcing materials, whether in sheet form or perforated sheet, or in any other form such as fibers, can be utilized to reinforce any of the above-noted layers such as an insulation layer, an intumescent layer, a foam layer, and even a reflective layer, to impart strength and structural integrity thereto.

The corrugated layer generally has numerous confined gas domains such as air therein as can any of the above other layers with the exception of the surface of the reflection layer. Thus, the above noted various insulation materials, intumescent materials, and reinforcing materials can have pockets of air or other gas therein. Alternatively, the corrugated layer can be a gas (e.g. air) layer between the insulation layer.

Cellular or foamed materials, such as foamed compositions, which can be used in the present invention are generally nonflammable and useful for thermal management, fire protection and other high temperature applications. The capability of the present invention to withstand temperatures beyond 800° C. allows its use in applications that cannot be met by organic-based foamed materials and/or its derivatives. Inorganic cellular materials, such as foamed compositions, made from carbon, glass or ceramic materials, can resist similar temperatures but are costly limiting their use for large scale thermal management needs and/or cost sensitive applications. Cellular materials prepared for the present invention can also be molded into complex as well as simple shapes as required and/or specifically shaped using traditional machining equipment. Cellular materials, such as foamed material can be either structural (integral) or nonstructural, formed with or without the use of a foaming agent. A syntactic foamed material can also be prepared utilizing the present invention and the appropriate fillers such as microspheres, microballoons and/or microcapsules.

In the preparation of the various types of barrier or multi-layer thermal barrier systems, generally one or more outer layers are made with a material which has good resistance to heat and/or flame and also burn-through such as the inorganic polymer matrix derived from an alkali silicate, or one or more of the inorganic based materials such as the oxide-based cements, refractory materials, oxides of aluminum, and the like. The multi-layer thermal barrier systems optionally may contain an intermediate layer located between one or more outer layers and one or more core layers. The core layer can be a substrate sought to be protected such as a low melting point metal or a flammable material such as wood, or other organic material.

The various above-noted combinations of layers to form different types of laminates can be referred to as hybrid laminates or hybrid systems which can be made by joining, via lamination, etc., a thermal barrier inorganic lamina or laminate to an organic or inorganic composite core.

A multitude of thermal barrier systems or multi-layer composites can be made utilizing, in any order, one or more layers comprising the inorganic polymer matrix derived from an alkali silicate such as reacted with a non-silicate network former and/or a reactive glass, water, an optionally one or more secondary network modifiers; and at least one layer of any of the following layers, an insulation layer, an intumescent material layer, a foam layer, a reflective layer, a reinforcing layer, or a corrugated layer; preferably with one or more of any of the above layers containing a reinforcing material such as generally a fiber, etc., therein. The number of layers of the thermal barrier laminates or systems of the present invention can vary widely such as generally from about 2 to about 10 layers, and typically or preferably from about 2 to about 3, or about 4, or about 5 layers, or about 7 layers.

The alkali silicate resins or composites thereof, e.g. containing reinforcing materials, can be utilized in many ways in creating systems whose purpose is to increase thermal resistance or to create a thermal barrier system capable of preventing thermal or flame penetration, oxygen penetration, thermal insulation (orders of magnitude less then steel) and strength retention during and after the thermal or fire exposure (level of retention dependent upon exposure time and/or temperature). For example, an alkali silicate resin layer as thin as 0.020 inches can be used as a thermal and/or fire barrier. These properties can be further optimized for more demanding scenarios with the incorporation of high temperature insulation. The combination of an alkali silicate resin layer or composite thereof and insulation can improve durability, reduce heat transfer and act as an oxygen barrier. These systems can then be used as thermal and/or fire protection for substrates such as wood, steel or composite materials. Multiple layers of an alkali silicate resin layer or composite thereof and insulation can be engineered to specific physical, mechanical and thermal requirements. Incorporating reflective surfaces on the interior or internal alkali silicate resin layer or composite thereof can further improve the systems performance by reducing the radiate heat conduction. Alkali silicate resin or composites alone or with a rigid non-flammable insulation core can function as a load bearing structures, which are completely non-flammable.

Thermal barrier or fire protective systems are designed based on thermal or fire protection requirements, allotted envelope for the system, mechanical requirements, physical requirements and depending on the market, cost. Some thermal or fire barriers can be a simple 0.020 inches thick alkali silicate resin layer or composite thereof with the purpose of preventing flame penetration (alkali silicate resin layer/Carbon laminate—2 ply used for fire protection of nacelles). Other systems can consist of multiple layers intended to insulate, prevent thermal or fire penetration and maintain a low cold side temperature for a long duration (a VSV material), i.e. an alkali silica resin layer having a reinforcing metal screen and outer layers of glass was used as the cover layer over ceramic blanket to reduce convention heat transfer and make the system more durable.

The various thermal barrier laminates, or multi-layer thermal barrier systems of the present invention can be applied to a wide variety of applications such as reinforced missile silos, ship decks, aircraft carrier blast and heat shields, fire barriers, hot gas filters, protective coatings, electrical panels and boxes (with and without EMI shielding), engine covers, or any application that would need, advantageously, protection from fire and heat transfer damage, corrosion resistance, lifecycle cost savings and weight reduction. Additionally, this technology can be applied to reinforce insulator inserts for aircraft brakes. The insulator within each piston thermally isolates the friction head from the hydraulic system. Compared to conventional resins, some of which decompose below 450° C., the matrix binders of the present invention have much higher thermal stability (to above 1000° C.), and in contrast to metals, the composite of the present invention has superior insulation performance. This protects the hydraulic system and can reduce the weight and/or associated costs. In comparison to ceramics, the composite of the present invention is tougher because due to the presence of the reinforcing fibers, but less expensive than ceramic matrix composites due to the materials and processes utilized.

The thermal barrier systems of the present invention can also be used in those applications where good thermal and physical stability are desired, such as those applications for which ceramic composites are used. Applications would include uses in aerospace, marine, mass transportation, structural, and architectural applications, ranging from simple applications requiring fire resistance and/or thermal resistance to more sophisticated fire proof applications, including high temperature and long duration protection, heat and fire protection for conduits, cable trays, electrical transmission lines, gas and oil pipelines, fire and heat protection for structural steel columns, beams and open web joists, and bulkheads and other surfaces for boats, ships, aircraft, buses, cable cars, trolleys, and the like.

In accordance with the concepts of the present invention, Table 1 serves as a sample illustration of the various different types of thermal barrier systems which can be utilized according to the present invention.

The following Table 1 is presented as illustrative of applications for the present invention, but are not considered to be exhaustive of or limiting the uses for the invention:

TABLE 1

| | | Structure | Inorganic | |
|---|---|---|---|---|
| | | (Composite = Reinforced | Laminate | |
| Example | Application | Inorganic Resin Composite) | Materials | Comment |
| A | light weight fire stop | Inorganic Composite | Carbon fiber/ | Thickness can range |
| | or barrier | | alkali silicate | from 1 ply to multiple |
| | | | resin | |
| B | Thermal/Fire barrier- | Inorganic Composite/ | Carbon or | Core can be insulative |
| | light weight; low cost | Insulation/Composite | glass fiber/ | materials including |
| | | | alkali silicate | honeycomb |
| | | | resin | |
| C | Thermal/Fire barrier | Wood/ | Stainless steel | Layers can be |
| | Door structure | Inorganic Composite/ | fiber/ | optimized for |
| | meeting 90 minute | Intumescent Mat/ | alkali silicate | performance |
| | test | Inorganic Composite/ | resin | |
| | | intumescent Mat/Inorganic | | |
| | | Composite/Wood | | |
| D | Thermal/Fire barrier | Intumescent coating/ | Glass or | Provides fire and |
| | for Marine application | Inorganic Composite/8 lb | stainless steel | thermal barrier |
| | | Mineral blanket/Bulkhead | fiber/alkali | |
| | | structure | silicate resin | |
| E | Fire Barrier | Corrugated Inorganic | Fiber/alkali | Composite is molded |
| | Incorporating air | Composite | silicate resin | as a corrugated |
| | spaces | | | material |
| F | Organic Composite | Inorganic Composite/ | Fiber/alkali | Adds fire resistance |
| | having improved fire | Organic Composite/ | silicate resin | and improved |
| | resistance | Inorganic Composite | | strength to organic |
| | | | | composite |
| G | High level thermal | Inorganic Composite/ | Fiber/alkali | Foam can be glass, |
| | and fire resistant | Inorganic foam/ | silicate resin | carbon, and the like |
| | performance material | Inorganic Composite | | fireproof foam |
| | | | | systems |
| H | Higher strength fire | Inorganic Composite/ | Composite is | Mineral core is known |
| | barrier | Mineral Core/ | of stainless | fire core and |
| | | Inorganic Composite | steel fibers/ | composite improves |
| | | | alkali silicate | fire barrier |
| | | | resin | performance |

Still other examples of suitable thermal laminates or systems include Examples 1 through 8 of Table 2 wherein the material type “composite” is an inorganic polymer composite containing an alkali silicate resin and a reinforcing material.

TABLE 2

| Example | Layer | Material | Material Type | Advantage | Comments |
|---|---|---|---|---|---|
| 1 | 1 | FR/C | Composite | Light weight fire stop/barrier | Thickness can range |
| | | | | | from 1 ply to |
| | | | | | multiple |
| 2 | 1 | FR/C (or G) | Composite | Thermal/Fire Barrier | Core can be any |
| | 2 | Balsa | Insulation | Light weight low cost | insulative material |
| | | | (wood) | | including |
| | 3 | FR/C (or G) | Composite | | honeycomb |
| 3 | 1 | MDF | Wood | Thermal/Fire Barrier | Layers of FR/SS and |
| | 2 | FR/SS | Composite | Core | Palusol can be |
| | 3 | Palusol | Intumescent | Thin 90 min door | optimized for any |
| | | | mat | | performance |
| | 4 | FR/SS | Composite | Core | |
| | 5 | Palusol | Intumescent | | Intumescent mats |
| | | | mat | | can be any of many |
| | 6 | FR/SS | Composite | | types |
| | 7 | MDF | Wood | | |
| 4 | 1 | Coating | intumescent | Thermal/Fire Barrier | System is being |
| | | | coating | | evaluated for the US |
| | 2 | FR/G (or SS) | Composite | Superior Performance | Navy |
| | 3 | Blanket | 8 lb mineral | vs. twice as much blanket | |
| | | | blanket | | |
| | 4 | Steel | Bulkhead | | |
| | | | structure | | |
| 5 | 1 | FR/Any | Corrugation | Air spaces improve thermal | Any means of |
| | | | | performance | generating air |
| | | | | | spaces works —can |
| | | | | | be easily optimized |
| 6 | 1 | FR/Any | Composite | FyreRoc - Fire Barrier | FyreRoc composite |
| | 2 | RP | Organic | Improving Fire performance | improves strength |
| | | | Composite | of any Organic Composite | and fire performance |
| | 3 | FR/Any | Composite | | of organic laminate |
| 7 | 1 | FR/Any | Composite | High level of thermal | Foams can be glass, |
| | | | | insulation and fire | carbon, etc. With |
| | | | | performance | the correct foam |
| | 2 | Foam | Inorganic | Insulation and fire | can be Fire Proof |
| | | | foam | performance | System |
| | 3 | FR/Any | Composite | performance | |
| 8 | 1 | FR/SS | Composite | Improve the strength after | Mineral core is |
| | | | | fire of the mineral core | known fire core - |
| | 2 | Min. Core | Mineral Core | | FR/SS improves on |
| | 3 | FR/SS | Composite | | inherent weakness |

Material Code
FR = Inorganic polymer matrix derived from alkali silicate
C = Carbon Fiber
G = Glass
Any = Any Fiber
SS = Stainless Steel Fiber
MDS Medium Density Wood
RP = Reinforced Plastic

As apparent from Tables 1 and 2, many different types of thermal laminates or structures can exist composed of at least one inorganic polymer layer comprising an alkali silicate material and other layers such as any of at least one insulation layer, intumescent layer, foam layer, corrugated layer, reinforcing material layer, and the like.

The resulting thermal barrier laminate or system exhibit dimensional stability up to about 900° C. and higher, depending upon the final formulation and chosen processing and possesses excellent properties with respect to flame, smoke and toxicity. A thermal barrier laminate or system made using the inorganic resin composition of the present invention is lightweight with good thermal insulating characteristics. Various shapes are relatively inexpensive to manufacture primarily due to the low temperature and pressures needed to affect cure of the composite.

The inorganic resin compositions are useful as fire proof binders, bulk molding materials, sheet molding compositions, adhesives, coatings, neat resin compositions, cellular materials, such as foamed compositions or thermal barrier laminates. As thermal barrier laminate or system, the inorganic resin composition can be formed into shaped objects when cured. Alternatively, the composition is used to impregnate a fabric, which may be combined with other similarly impregnated fabrics to form a lay-up, which in turn is then shaped and cured to form a shaped composite or object, similar to a bulk material, but with the benefit of the reinforcement provided by the fabric. The compositions of the present invention are useful in those applications where good thermal and physical stability are desired, such as those applications for which ceramic composites are used.

When using unidirectional fiber, the new thermal and fireproof inorganic resins have mechanical properties comparable with organic resin composites. Woven fabrics composites using the resin system are a little more problematic due to the difficulty in penetrating the fiber bundles. However, the FST performance of the inorganic system with an organic based structural component is believed to provide some mitigation.

Thermal properties consisting of thermal conductivity, thermal expansion and specific heat have been evaluated for glass, stainless steel and carbon reinforced inorganic resin composites. The thermal performance evaluated by these methods showed consistent performance for new fireproof inorganic composites from room temperature to 800° C.; impossible with organic resin systems.

The thermal barrier laminate or systems can be made using standard lamination techniques such as inorganic high temperature adhesion or high strength organic adhesion depending upon the required properties of the system. In addition, hybrid systems can be made by joining, via lamination, an inorganic thermal barrier layer or laminate to an organic laminate core. The thermal barrier systems or laminates function not only as a thermal barrier, but also a fire barrier, an oxygen barrier, and an insulating layer.

Thermal barrier systems, made from fireproof inorganic resins, can be used to protect organic based materials from heat or fire for a given time interval. The inorganic resin composition used to form the thermal barrier systems is unique in that it does not rely on insulating the organic thermal barrier layer from heat. Instead, the inorganic resin composition functions as a thermal, fire, or oxygen barrier. Acting as a thermal, fire, or oxygen barrier, these inorganic layers prevent combustion but not decomposition. Thus, using a hybrid system to improve the performance of an organic material can be accomplished as long as attention is paid to the method by which the core material is insulated.

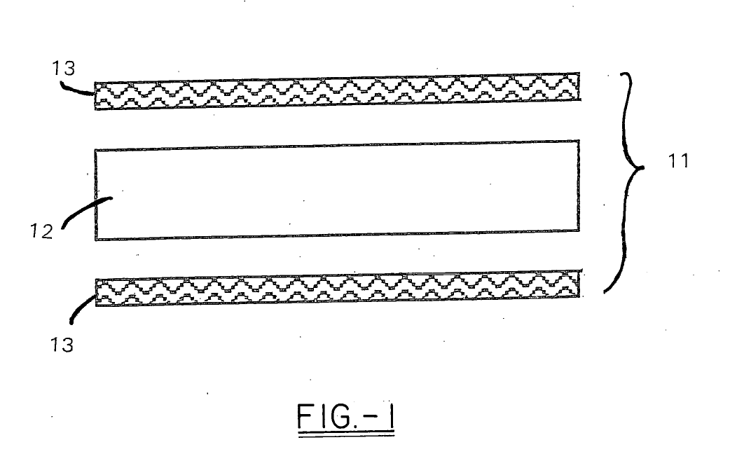

FIG. 1 illustrates a hybrid laminate 11 in which an inorganic core 12 is joined to or covered by fire resistant laminates 13. The core 12 could be, for example, an epoxy or phenolic compound or laminate, while the fire resistant laminates 13 could be, for example, a non-woven fiberglass mat which has been impregnated with an alkali silicate resin. The mat could be a single layer or a laminate of more than one layer depending upon the performance needs or desired configuration.

The thermal and fireproof laminates evaluated consist of an inorganic resin (alkali silicate resin) pre-impregnated into stainless steel mats compression molded from 27° C. to 66° C. The mats consisted of two layers, on 0° and one 90° needled together into a single ply. The porosity of the mats results in approximately 80 vol. % resin in the finished product. The resulting laminate is 0.102 cm thick with a density of 2.5 gms/cm³ (Inorganic laminate “A”). Additional fireproof laminates consist of fire resistant inorganic resin impregnated into glass fabric resulting in a thickness of 0.064 cm and a density of 1.90 gms/cm³ (Inorganic laminate “B”) and fireproof inorganic resin impregnated into a glass fiber mat resulting in a thickness of 0.089 cm and a density of 2.3 gms/cm³ (Inorganic laminate “C”).

Other embodiments of the present invention are shown in FIG. 2. As shown at the top middle portion of FIG. 2, the alkali silicate resin can be reinforced with any suitable type of material such as glass reinforcement, or carbon reinforcement, or steel reinforcement to make a alkali silicate reinforced composite or layer. The composite can be utilized as is to form a fire protected structural component, or be applied to various substrates such as an organic resin layer, wood, steel, etc., to form a structural component. Alternatively, the alkali silicate composite or layer can form an insulation system by adding different types of insulation thereto such as ceramic, mineral, and the like. Alternatively, an intumescent system can be formed by adding various different types of intumescents such as an alkali silicate, an exfoliate graphite, vermiculite, etc., to the alkali silicate composite. Similarly, various different types of inorganic foams, such as glass or carbon, can be added to the alkali silicate composite to form a foam system. These systems as well as other systems, not shown, can be formed into different types of structures such as a simple sandwich, a multi-layer sandwich, etc. to form still other systems with the same then being applied to a substrate to form a fire protected structural system.

The substrate to be protected can generally be any type of material which is often esthetically pleasing but generally has a low burning point or ignition temperature. Common substrates include wood such as numerous types of hardwood, for example maple, oak, ash, etc., or soft wood such as various types of pines, etc., as well as plywood, laminated wood, and so forth. Other substrates include organic resins which generally encompass numerous types of polymers such as polyesters, polyethers, polyolefins, polyvinylchloride, epoxies, nylons, phenolics, and the like. Still other substrates include low melting point metals such as aluminum, brass, bronze, and even various types of steel. The two or more alkali silicate composites or layers can be adjacent to one another or separated by another layer and the like.

### High Heat Distortion Resistant Inorganic Laminate

The heat distortion resistant inorganic thermal barrier systems or laminates of the present invention, as noted above and hereby fully incorporated by reference, generally relate to at least one exterior layer of an alkali silicate composition containing a reinforcement material and to a least one core layer. Such systems or laminates have been found to possess very desirable temperature resistant, insulation properties, as well as quench heat distortion resistant properties. By way of summary, the alkali silicate containing layer, also referred to as an inorganic polymer matrix composition, is generally prepared by reacting an alkali silicate solution, one or more non-silicate oxoanionic compounds optionally but desirably including at least one phosphorus compound, optionally but desirably including an acidic reactive glass, water, optionally, one or more secondary network-linking units such as multivalent cation(s) selected from Groups 2, 3, 4, 5, 6, 7, 8, 10, 11, 12, 13, 14, 15, or 16 of the Periodic Table such as alkaline earth salt, and optionally a clay and/or oxide filler. Alternatively, in lieu of the alkali silicate, precursors such as a silica source and an alkali hydroxide or oxide can be utilized. Regardless of preparation route, additional components such as functional and/or nonfunctional fillers, as well as other network forming materials and modifiers can be optionally incorporated as desired. The alkali silicate containing layer desirably can be reinforced with one or more different fibers. The preparation of the alkali silicate containing layer is set forth hereinabove and is hereby fully incorporated by reference. Such layers have good thermal resistance, as noted above, of at least about 400° C. or about 500° C., desirably at least about 640° C. or at least about 700° C., and preferably at least about 800° C. or about 900° C. or about 1,000° C., with respect to no degradation.

With regard to the above noted utilization of one or more reinforcing fibers in the one or more alkali silicate layers, generally inorganic reinforcing woven and/or non-woven, continuous and/or discontinuous fibers or combinations thereof, having high heat resistance are utilized since organic fibers or organic containing fibers such as polymers, or polymer coated fibers can degrade. By high heat resistance, it is generally meant that such reinforcing fibers generally have a thermal resistance of about 400° C. or about 500° C. or higher, desirably about 640° C. or about 700° C. or higher, and preferably about 800° C. or about 900° C., or about 1,000° C. or higher without degradation or decomposition. Examples of such fibers are set forth hereinabove and are hereby fully incorporated by reference, and preferred fibers include, but are not limited to, high Tg glass fibers, mineral fibers, carbon fibers, graphite fibers, ceramic fibers, silicon carbide fibers, silicon oxycarbide fibers, basalt fibers, aluminum silicate fibers such as Nextel® fibers, e.g. Nextel® 312 fibers which are available from 3M, stainless steel fibers, titanium fibers, nickel alloy fibers, aramid fibers, and the like, and combinations thereof.

The preparation of an alkali silicate layer containing reinforcing inorganic fibers therein is achieved in one embodiment in the following manner. The fibers are applied as a woven or non-woven, continuous or discontinuous, etc. construction, to a mold having a desired shape, size, contour, etc., and then coated with the alkali silicate containing composition, which as noted hereinabove can contain one or more non-silicate network formers such as any of various acidic oxoanionic compounds such as boric acid, phosphoric acid, sulfuric acid, various phosphate compounds and/or one or more reactive acidic glasses. Such compositions, which desirably contain water, can be applied to one side of the fibers, and preferably to both sides of the fibers to impregnate and coat the same. Desirably, the alkali silicate containing layer can have from 1 to about 10 or more sub-layers and desirably from 1 to about 10 or more sub-layers of coated fibers therein in the form of woven fibers, e.g. cloth or fabric sub-layers. Once the desired shape or form has been made, the alkali silicate containing layer can be B-staged. That is, the alkali silicate containing laminate is slowly cured at ambient and/or a slightly elevated temperature such as 25° C. to 60° C. or to about 100° C. for a sufficient period of time to impart structural integrity to the alkali silicate containing layer so it can subsequently be handled or have a core layer applied thereto without breaking or deforming. B-staging generally allows non-reacted water to be removed from the alkali silicate containing layer and subsequent heating of course removes further water. Such partial pre-cure is generally conducted in steps for various periods of times at various subsequent ramped up temperatures. Pressure can be applied during the partial cure or B-staging operation if desired. Such B-staging is well known to the art and to the literature.

As noted, the high heat distortion resistant laminate contains at least one core layer to provide enhanced structural and thermal properties such as dimension distortion resistance, structural strength, thermal insulation, high temperature resistance, thermal shock resistance, impact resistance, crack resistance, reduced weight, air spaces, or the like.

The core layer material generally comprises any high heat distortion resistant compounds and thus organic compounds including organic polymers are avoided. Suitable core materials include one or more of various silicates such as an aluminum silicate, aluminosilicate, alumina, or an alkali aluminum silicate; various refractory materials such as boron carbide, silicon carbide, silicon nitride, and the like; various ceramics such as a structural clay product; various oxides such as various metal phosphates and aluminates; as well as magnesium oxide, titanium oxide, zirconia, silica, titania, and the like. Silicon carbide and aluminosilicate and alumina are preferred core materials.

Although it can be a solid, in order to provide a lightweight structure, the core layer preferably contains one or more air spaces therein and thus can be a honeycomb structure, a corrugated or undulating structure, a pillar structure, a foam, a cellular material, a fiber mat or fiber blanket having air spaces therein with or without binders, or any material having cavities or recesses therein. While the lightweight core structure can be open, e.g. a honeycomb, it is desirably covered or closed, such as on the top and bottom surfaces thereof. These and other core structures having air spaces, cells, etc., therein are well known to the art and to the literature. A fiber mat or blanket is preferred. A fiber mat or blanket is generally made by laying short fibers, for example up to about one or about two inches in length, on a porous backing such as a perforated metal plate, applying a binder slurry thereto that partially or totally coats the fibers and then forming the fibers and binders into a layer or sheet such as by pulling a vacuum to compact the fibers and binder. Subsequently the mat or blanket can be cured and will inherently contain air spaces, pockets of air, cells of air, etc. therein. The mat or blanket can be subsequently cured as noted herein below.

The core layer can optionally contain reinforcing fibers therein such as those set forth hereinabove that are utilized to reinforce the alkali silicate layer, hereby fully incorporated by reference. Such core fibers can be arranged so that they are continuous or discontinuous, non-woven or woven; or combinations thereof. Preferred fibers include, but are not limited to, high Tg glass fibers, mineral fibers, carbon fibers, graphite fibers, ceramic fibers, silicon carbide fibers, silicon oxycarbide fibers, basalt fibers, aluminum silicate fibers such as Nextel® fibers, e.g. Nextel®312 fibers which are available from 3M, stainless steel fibers, titanium fibers, nickel alloy fibers, aramid fibers, and the like, and combinations thereof. Silicon carbide and silicon oxycarbide fibers are preferred.

The core layer has desirable thermal resistance of about 400° or about 500° C. or higher, desirably about 640° C. or about 700° C. or higher, and preferably about 800° C., or about 900° C., or about 1,000° C. or higher without degradation and can be formed to any desired shape, size, contour, etc. such that it is desirably similar to the shape, size, contour, etc. of the alkali silicate containing layer to form a desired laminated article.

As with the exterior layers, the core layer can contain one or more sub-layers such as a honeycomb layer, an undulating layer, a foam layer, a fiber mat or a fiber blanket layer, etc., and the like. The core layer is formed into a desired shape and can be B-staged in a similar manner as the exterior layer. Various conventional compounds can be utilized as a binder for the core layer and the same are known to the art and to the literature such as starch and the alkali silicate inorganic resin composition of the present invention. Starch will effect a partial cure at low temperatures whereas at the high and final temperature cure, the starch will burn away and the alkali silicate resin will bind the core compounds. The partial cure is performed at a temperature generally from about 25° C. to about 60° C. or to about 100° C. so that the core layer and/or sublayer has structural integrity and yet is flexible and can be applied to a mold, form, etc., to form a desired shape and/or contour, and the like.

Once the one or more precured alkali silicate containing layers with or without fiber reinforcement and the one or more precured core layers with or without fiber reinforcement are made, they are laid upon one another or contacted in any desired order and formed into a desired shape or contour. The laminate is then cured in an oven at suitable lamination temperatures and, if desired, under pressure to produce a single or integral article. Curing temperatures will vary with regard to the type of alkali silicate and core layer compositions chosen and generally range from about 60° C. to about 200° C. and desirably from about 80° C. to about 150° C. for suitable periods of time. Optionally, a post cure can be utilized to impart improved end use properties such as strength, thermal shock resistance, and the like. Such post cure cycle includes temperatures of about 300° C. to about 800° C. for suitable periods of time.

While a preferred method of precuring the one or more core layers and the one or more exterior layers and subsequently mating the exterior layers and the core layer(s) has been set forth, it is to be understood that many other routes can be utilized such as laying the core layer in the mold and applying one or more exterior layers thereto and subsequently producing a final cured article without any B-staging, and the like.

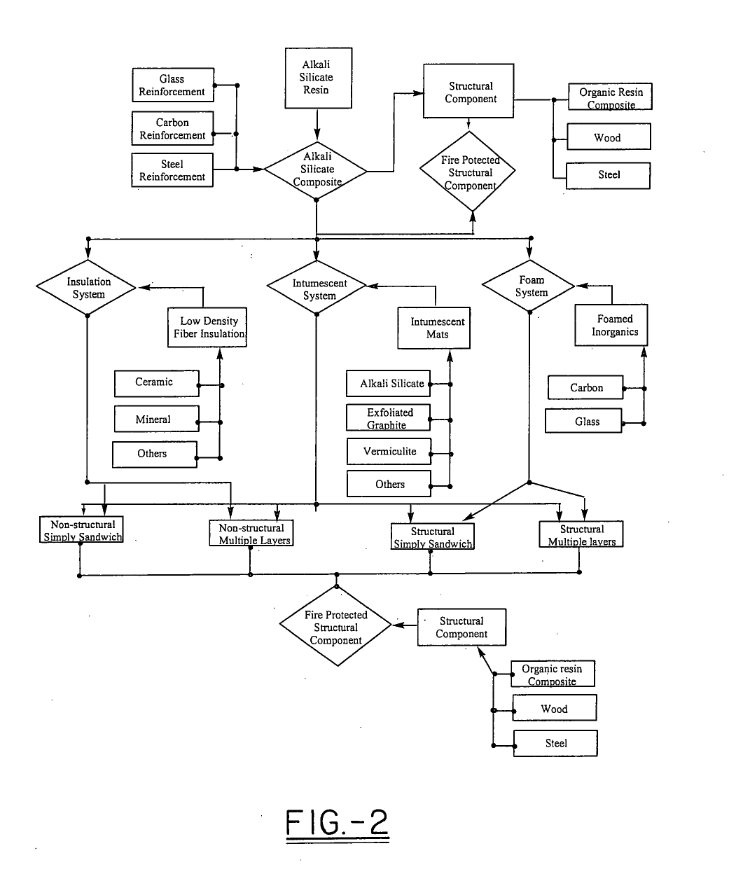

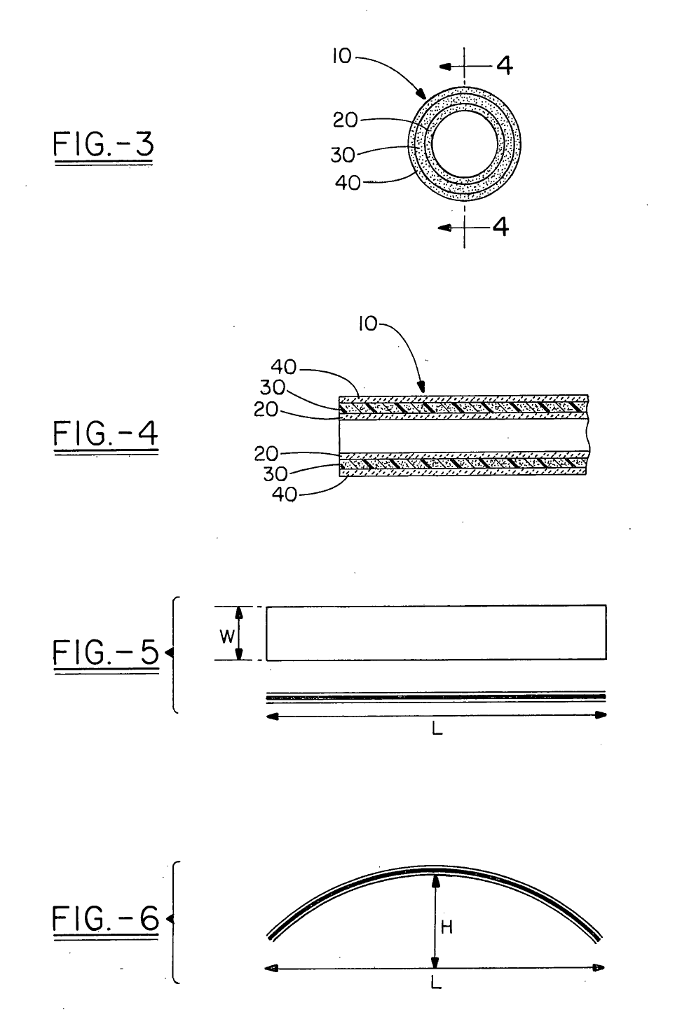

Referring to FIGS. 3 and 4, a typical preparation of a laminate in the form of tube 10 and cure thereof will now be described. An internal preformed support, not shown, has a layer comprising alkali silicate, etc., formed thereabout. A reinforcing fiber is desirably utilized as in the form of a weave and the alkali silicate containing composition is applied thereto to form a first or internal layer 20 of a tube. Vacuum bagging can be utilized, wherein the support contains one or more apertures therein so that a vacuum can be drawn through the support to form a uniform cylindrical layer, comprising alkali silicate, the reinforcing fiber, etc., about the support. In order to maintain structural integrity of the alkali silicate containing layer, it can be pre-cured (B-staged) as set forth above generally by initial ambient cure followed by a higher temperature cure to form a partially cured article. Subsequently, a core layer composition is applied about internal layer 20. As noted above, desirably the core layer contains air spaces therein such as a honeycomb, an inorganic cellular material, a foam, an open or closed cell fiber mat or blanket, etc. In a manner similar to the cure of internal layer 20, the core layer can be partially cured (B-staged) to maintain structural integrity such that it will not sag, deform, etc. Upon formation of core layer 30, external layer 40 is formed in a similar manner as with internal layer 20. External layer 40 can be the same type of material as the internal layer, for example an alkali silicate containing composition, or a different type of alkali silicate containing composition. The various thicknesses of each layer can be adjusted to provide suitable properties for a desired end use. Once laminate or tube 10 is formed, it can then be subjected to a final curing process at temperatures of about 60° C. to about 200° C.

The high heat distortion resistant laminated articles of the present invention comprising the one or more alkaline silicate containing layers optionally but preferably containing reinforcing fibers and the one or more core layers optionally containing reinforcing fibers can have many configurations. For example, one alkali silicate containing layer can be utilized with one core layer, or a core layer can be utilized with each side being adhered or connected to an alkali silicate containing layer. Another embodiment relates to two alkali silicate containing layers and a core layer wherein a relatively thin acidic glass containing layer is utilized between the alkali silicate containing layer and the core layer. The total number of alkali silicate containing layers and core layers can range from about 2, or about 3, or about 5, to about 10, or to about 15. In as much as each individual layer of laminate can be made out of different types materials, customized or tailor made end products can be made having desired physical properties such as low weight, high temperature resistance, good impact resistance, good insulation, good thermal, and good quench distortion resistance such as minimal permanent dimensional change, or combinations thereof.

Notable properties of the heat distortion resistant laminates of the present invention include high temperature resistance to degradation, and surprisingly good quench distortion resistance values. The laminates of the present invention can withstand high temperatures of at least about 400° C. or about 500° C., desirably at least about 640° C. or at least about 700° C., and even as high as at least about 800° C. or about 900° C. or at least about 1,000° C. for extended periods of time without degradation. A surprising and unexpected property of the heat distortion resistant inorganic laminates of the present invention is that a very low quench steepness index is achieved when a very hot laminate is rapidly quenched in a low temperature liquid such as water. Heretofore, due to the coefficient of thermal expansion of materials, laminates, etc., the surface layer when exposed to a much cooler temperature such as ambient water, contracted or shrunk and caused the material or laminate to buckle, often destroying the shape and/or integrity of the laminate, material, etc. In contrast, the heat distortion laminates of the present invention when quenched at a temperature of 640° C. in water at 22° C. have very good quench distortion resistance values as quantified by a quench steepness index value of about 2.0% or about 1.0% or less, desirably about 0.5% or less; more desirably about 0.2% or less; and preferably about 0.1% or less of its original dimensional shape.

The determination of the quench distortion steepness index values are set forth by ASTM A 1030/A 1030M-05 Appendix X1. The standard specified by ASTM A 1030/A 1030M-05 was slightly modified as follows and values set forth in the Examples and the Claims are according to the modified ASTM test. A rectangular piece of material having a length L is heated to a desired temperature for a desired time. Accordingly, the samples herein were heated to 640° C. for 60 minutes, and then quenched asymmetrically or in total in a 22° C. water bath. In the asymmetric quench test, the samples were removed from a furnace and a water stream was impinged on only the top surface. In the total immersion quench test, the samples were removed from the furnace and totally immersed in a water bath at 22° C. In the table set forth herein below, (see FIGS. 5 and 6) “H” is the curve height above the original surface plane wherein “L” is a length of the laminate sample. Si, that is the steepness index, is H divided by L. Percent of steepness is H divided by L times 100.

### EXAMPLES

The following examples serve to illustrate and describe a preferred embodiment of the present invention but not to limit the same in that other embodiments can be utilized.

A laminate in the form of a panel was fabricated for testing with regard to thermal shock resistance as quantified by a quench steepness index value. The panel contained face sheets on both top and bottom with an insulative core. This panel was made by first curing the bottom face sheet; then bonding the core material and curing the top face sheet in a separate step. The process is discussed below along with the test results.

The bottom and top layers of the panel were fabricated using an aqueous inorganic resin slurry comprising 70 wt. % potassium silicate, 1.8 wt. % potassium dihydrogen phosphate, 9.7 wt. % clay, 2.04 wt. % boric acid, 1.85 wt. % magnesium oxide, and 3.6 wt. % of a reactive acidic glass such as borophosphosilicate. The slurry was impregnated using squeeze rolls into a silica carbide fabric. The excess resin was then removed to obtain a prepreg containing approximately 70 wt. % resin slurry and 30 wt. % fabric reinforcement. The prepreg was allowed to stage for approximately two hours before the prepreg was laid up into a multiple (four) ply bottom layer and vacuum bagged. The bagged bottom layer was then cured in an autoclave at 100 psi of pressure and 80° C. for 4 hours, then 110° C. for 4 hours and finally 150° C. for 4 hours.

The core, an aluminosilicate ceramic fiber mat containing air spaces therein, was laid up over the bottom layer using the same alkali silicate resin system described immediately above as the adhesive. Next using the same process described immediately above a multiple (four) ply layer was laid up over the core and vacuum bagged. The panel was then autoclave cured using the same time and temperature as the bottom layer cure but at a lower pressure, 50 psi, to prevent crushing the core. The panel after demolding was post baked at 400° C. for approximately 24 hours at which time the panel was completed.

The panel was tested by a modified ASTM A1030A 1030M-05 using in some cases multiple, e.g. five, immersions. The test was done by inserting the panel into a high temperature oven at 640° C. for approximately 60 minutes then quickly removing the panel and quenching it in 22° C. water. A second method of exposure was quenching only the top surface of the 640° C. panel with the 22° C. water. This can be considered a more “real world” application test as the panel is only exposed to water on one surface during the application. The panels were then evaluated for dimensions stability, a critical parameter in many applications.

Table 1 sets forth test results of the panel laminate of the present invention versus 304 stainless steel.

TABLE 1
Steepness Index
Per ASTM A 1030/A 1030 M-05 Appendix X1

| | Material | | | | | |
|---|---|---|---|---|---|---|
| | SS-304 | SS-304 | SS-304 | 3 layer panel* | 3 layer panel* | 3 layer panel* |
| | Sample size ˜152 × 30 × 1 mm, ˜34 g | | | Sample size ˜ 140 × 25 × 2 mm, ˜14 g | | |
| Water | None | Asymmetric | Total Immersion | None | Asymmetric | Total |
| Quench | | | | | | Immersion |
| # of Cycles | 0 | 5 | 5 | 0 | 5 | 5 |
| H (mm) | 0.50 | 12.00 | 3.50 | 0.10 | 0.10 | 0.15 |
| L (mm) | 151.8 | 150.5 | 152.1 | 139.8 | 140.1 | 139.6 |
| SI | 0.0033 | 0.0797 | 0.0230 | 0.0007 | 0.0007 | 0.0011 |
| S | 0.33% | 7.97% | 2.30% | 0.07% | 0.07% | 0.11% |

*Potassium silicate (SiC fiber) bottom and top layer, aluminosilicate fiber mat core
SI = Steepness Index = H/L
S = % Steepness + H/L × 100
Cycle ≡ Sample heated to 640° C. for 60 minutes and quenched with water (@ 22° C.)
Asymmetric quench ≡ Sample removed from furnace and a water stream impinges the top surface only
Total immersion ≡ Sample removed form furnace and immersed in a water bath (@ 22° C.)
Height (H) ≡ Curve height above surface plane
Length (L) ≡ Cycle length

As apparent from Table 1, the laminate construction of the present invention gave dramatic low quench steepness index values for example about 1/10 of 1% or less as opposed to the quench steepness index values of stainless steel of from about 2.3% to about 8%. Thus, the quench steepness index values of the laminates of the present invention were from about 23 times to about 80 times less than that of the stainless steel control!

The panel performance was unexpected and surprising considering the thermal shock resistance for most high temperature ceramic materials. The uniqueness of the inorganic laminate chemistry and laminate construction of the present invention is responsible for the surprising low steepness good thermal shock resistance and low quench steepness index values.

Suitable end uses of the high heat distortion resistant laminates of the present invention include high-temperature applications which can be subjected to a rapid cooling such as water or air wherein a crack-free, low dimension distortion or distortion free result is desired. The laminate further has many applications since unlike metals, it can readily be produced having contours, bends, and the like. One end use is a component for an exhaust system for commercial vehicles such as automobiles and trucks, military vehicles such as personnel carriers, tanks, and amphibious vehicles, jet engines, ship and marine exhaust systems, and the like. By exhaust system it is meant any exhaust structure that extends from an engine and thus includes manifolds, tailpipes, extension pipes, catalytic converters, mufflers, and the like. Another end use is various exhaust fairings. Still other end uses include various heat shields which can be subjected to either rapid heating and/or cooling such as deflection walls with respect to the exhaust of jet engines, or shields or other equipment used in fighting fires, missile nose cones, missile skins, and the like. Additional end products are components for heat exchanges such as in boiler plants, electrical power generating plants, etc., wherein one side of the laminate is subjected to extreme temperatures of heat or fire and the other side is subjected to ambient or cold temperatures such as air or water.

While in accordance with the Patent Statutes, the best mode and preferred embodiments have been set forth, the scope of the invention is not limited thereto, but rather by the scope of the attached claims.

What is claimed is:

1. A heat-quench distortion resistant laminate, comprising:
at least one layer of an alkali silicate inorganic resin composition wherein said inorganic resin composition comprises a) the reaction product of an alkali silicate or alkali silicate precursors derived from an alkali hydroxide or oxide and a silicate source, or combinations thereof, one or more non-silicate oxoanionic compounds optionally including at least one phosphorus compound, water, optionally one or more compounds containing one or more multivalent cations comprising Groups 2, 3, 4, 5, 6, 7, 8, 9, 10, 11, 12, 13, 14, 15, or 16 of the periodic table or any combination thereof, and optionally a clay or an oxide filler or both; or b) the reaction product of an alkali silicate or alkali silicate precursors derived from an alkali hydroxide or oxide and a silicate source, or any combination thereof, a reactive acidic glass, water, and optionally a clay or an oxide filler or both; or c) the reaction product of an alkali silicate or alkali silicate precursors derived from an alkali hydroxide or oxide and a silicate source, or combinations thereof, one or more non-silicate oxoanionic compounds optionally including at least one phosphorus compound, a reactive acidic glass, water, optionally one or more compounds containing one or more multivalent cations comprising Groups 2, 3, 4, 5, 6, 7, 8, 9, 10, 11, 12, 13, 14, 15, or 16 of the periodic table or any combination thereof, and optionally a clay or an oxide filler or both; and
at least one core layer, said core layer comprising an inorganic composition having a thermal resistance of at least about 640° C.; and said laminate having a quench steepness index value of about 2% or less in a lateral direction according to modified ASTM Test A 1030/A 1030M-05.

2. A heat-quench distortion resistant laminate according to claim 1, wherein said quench steepness index value is based upon cooling the laminate from a temperature of about 640° C. in about 22° C. water.

3. A heat-quench distortion resistant laminate according to claim 2, wherein said alkali silicate, independently, comprises potassium silicate, sodium silicate, crystalline sodium silicate, crystalline potassium silicate, amorphous sodium silicate, amorphous potassium silicate, or lithium silicate, or any combination thereof,
wherein said at least one core layer contains one or more air spaces therein,
wherein each said at least one alkali silicate inorganic resin layer, independently, has a thermal resistance of at least about 700° C., and
wherein said quench steepness index value is 1% or less.

4. A heat-quench distortion resistant laminate according to claim 3,
wherein said at least one alkali silicate inorganic resin layer, independently, includes a reinforcing material, wherein said reinforcing material, independently, comprises at least one fiber, sheet, screen, or mesh, or any combination thereof; and
wherein said at least one core layer, independently, comprises an aluminum silicate, aluminosilicate, alumina, alkali aluminum silicate, refractory material, ceramic, metal phosphate, aluminate, magnesium, zirconia, silica, or titania, or any combination thereof.

5. A heat-quench distortion resistant laminate according to claim 4, wherein said alkali silicate, independently, comprises potassium silicate, sodium silicate, calcium silicate, or lithium silicate, or any combination thereof, wherein said reinforcing fibers of said alkali silicate inorganic resin layer, independently, comprise a nickel fiber, glass fiber, carbon fiber, graphite fiber, mineral fiber, oxidized carbon fiber, oxidized graphite fiber, steel fiber, metallic fiber, metal-coated carbon fiber, metal-coated glass fiber, metal-coated graphite fiber, metal-coated ceramic fiber, nickel-coated graphite fiber, nickel-coated carbon fiber, nickel-coated glass fiber, quartz fiber, ceramic fiber, aluminosilicate fiber, silicon oxycarbide fiber, titanium fiber, nickel alloy fiber, stainless steel fiber, brass-coated steel fiber, ceramic-coated carbon fiber, ceramic-coated graphite fiber, ceramic-coated glass fiber, aramid fiber, basalt fiber, alkaline resistant glass fiber, E-glass fiber, S-glass fiber, SiC fiber, or a BN fiber, or any combination thereof; and optionally including polymeric fibers, polymer-coated carbon fibers, polymer-coated graphite fibers, polymer-coated glass fibers, polymer-coated aramid fibers, or oxidized polyacrylonitrile fibers, or any combination thereof;
wherein said at least one alkali silicate inorganic resin layer and said at least one core layer, independently, have a thermal resistance of at least about 800° C., and
wherein said laminate has a quench steepness index value of about 0.5% or less.

6. A heat-quench distortion resistant laminate according to claim 5, wherein said at least one alkali silicate inorganic resin layer reinforcing fiber, independently, comprises a high Tg glass fiber, mineral fiber, carbon fiber, ceramic fiber, silicon oxycarbide fiber, aluminum silicate fiber, graphite fiber, basalt fiber, stainless steel fiber, titanium fiber, nickel alloy fiber, aramid fiber, SiC fiber, or a BN fiber, or any combination thereof;
wherein said at least one alkali silicate-inorganic resin layer and said at least one core layer, independently, have a thermal resistance of at least about 900° C.;
wherein said at least one core layer optionally contains reinforcing fibers, wherein said at least one core layer containing an air space, independently, comprises a honeycomb structure, a corrugated or undulating structure, a pillar structure, a foam, a cellular material, or a fiber mat or blanket, or any combination thereof; and
wherein said laminate has a quench steepness index value of about 0.5% or less.

7. A heat-quench distortion resistant laminate according to claim 6, wherein said alkali silicate is sodium silicate,
wherein said at least one core layer, independently, comprises a silicon carbide fiber mat or blanket, an aluminosilicate fiber mat or blanket, or an alumina fiber mat or blanket, or any combination thereof, and
wherein said laminate has a quench steepness index value of about 0.2% or less.

8. A heat-quench distortion resistant laminate of claim 1, wherein said alkali silicate inorganic resin composition is said a) composition;
wherein said oxoanionic compound, independently, comprises boric acid, phosphoric acid, sulfuric acid, sodium dihydrogen phosphate, disodium hydrogen phosphate, dipotassium hydrogen phosphate, potassium dihydrogen phosphate, ammonium hydrogen phosphate, metallic or nonmetallic phosphate salts or combinations thereof, compounds incorporating borate, sulfate, aluminate, vanadate, or germanate, or any combination thereof; and
wherein said optional multivalent cations, independently, comprise magnesium, calcium, zinc, aluminum, or titanium, or any combination thereof.

9. A heat-quench distortion resistant laminate of claim 4, wherein said alkali silicate inorganic resin composition is said a) composition;
wherein said oxoanionic compound, independently, comprises boric acid, phosphoric acid, sulfuric acid, sodium dihydrogen phosphate, disodium hydrogen phosphate, dipotassium hydrogen phosphate, potassium dihydrogen phosphate, ammonium hydrogen phosphate, metallic or nonmetallic phosphate salts or combinations thereof, compounds incorporating borate, sulfate, aluminate, vanadate, or germanate, or any combination thereof; and
wherein said optional multivalent cations, independently, comprise magnesium, calcium, zinc, aluminum, or titanium, or any combination thereof.

10. A heat-quench distortion resistant laminate of claim 7, wherein said alkali silicate inorganic resin composition is said a) composition;
wherein said oxoanionic compound, independently, comprises phosphoric acid, boric acid, sulfuric acid, or potassium dihydrogen phosphate, or any combination thereof;
wherein said cations, independently, comprise potassium, magnesium, calcium, zinc, aluminum, or titanium, or any combination thereof.

11. A heat-quench distortion resistant laminate of claim 1, wherein said alkali silicate inorganic resin composition is said b) composition;
wherein said reactive acidic glass comprises a compound of the formula
a(A′₂O)ₓb(G_{f}O)_{y}c(A″O)_{z}
where A′ represents at least one alkali metal glass modifiers that functions as a fluxing agent, G_{f} represents at least one glass formers, A″ represents, optionally, at least one glass network modifier, a represents the number of fluxing agents present and ranges from 1 to about 5, b represents the number of glass formers present and ranges from 1 to about 10, c represents the number of glass network modifiers and ranges from 0 to about 30, x represents the mole fraction of fluxing agent and is between about 0.050 and about 0.150, y represents the mole fraction of glass former and is between about 0.200 and about 0.950, z represents the mole fraction of glass network modifiers and is between 0.001 and about 0.500, x+y+z=1, and x<y, wherein A′ comprises lithium, sodium, potassium, rubidium, or cesium, wherein G_{f} comprises boron, silicon, phosphorus, sulfur, germanium, arsenic, antimony, aluminum or vanadium, and wherein A″O is at least one metallic glass modifier and comprises vanadium oxide, titanium oxide, zinc oxide, lead oxide, aluminum oxide, zirconium oxide, lanthanum oxide, cerium oxide, neodymium oxide, magnesium oxide, calcium oxide, strontium oxide, barium oxide, or silicon oxide, or any combination thereof.

12. A heat-quench distortion resistant laminate according to claim 6,
wherein said alkali silicate inorganic resin composition is said b) composition;
wherein said reactive acidic glass, independently, comprises a borophosphosilicate, phosphate, phosphoborate, borophosphate, or a borate glass, or any combination thereof.

13. A heat-quench distortion resistant laminate according to claim 1, wherein said alkali silicate inorganic resin composition is said c) composition;
wherein said reactive acidic glass comprises a compound of the formula
a(A′₂O)ₓb(G_{f}O)_{y}c(A″O)_{z}
where A′ represents at least one alkali metal glass modifiers that functions as a fluxing agent, G_{f} represents at least one glass formers, A″ represents, optionally, at least one glass network modifier, a represents the number of fluxing agents present and ranges from 1 to about 5, b represents the number of glass formers present and ranges from 1 to about 10, c represents the number of glass network modifiers and ranges from 0 to about 30, x represents the mole fraction of fluxing agent and is between about 0.050 and about 0.150, y represents the mole fraction of glass former and is between about 0.200 and about 0.950, z represents the mole fraction of glass network modifiers and is between 0.001 and about 0.500, x+y+z=1, and x<y, wherein A′ comprises lithium, sodium, potassium, rubidium, or cesium, wherein G_{f} comprises boron, silicon, phosphorus, sulfur, germanium, arsenic, antimony, aluminum or vanadium, and wherein A″O is at least one metallic glass modifier and comprises vanadium oxide, titanium oxide, zinc oxide, lead oxide, aluminum oxide, zirconium oxide, lanthanum oxide, cerium oxide, neodymium oxide, magnesium oxide, calcium oxide, strontium oxide, barium oxide, or silicon oxide, or any combination thereof.

14. A heat-quench distortion resistant laminate according to claim 4, wherein said alkali silicate inorganic resin composition is said c) composition;
wherein said reactive acidic glass, independently, comprises a borophosphosilicate, phosphate, phosphoborate, borophosphate, or a borate glass, or any combination thereof,
wherein said oxoanionic compound, independently, comprises boric acid, phosphoric acid, sulfuric acid, sodium dihydrogen phosphate, disodium hydrogen phosphate, dipotassium hydrogen phosphate, potassium dihydrogen phosphate, ammonium hydrogen phosphate, metallic or nonmetallic phosphate salts or combinations thereof, compounds incorporating borate, sulfate, aluminate, vanadate, or germanate, or any combination thereof; and
wherein said optional multivalent cations, independently, comprise magnesium, calcium, zinc, aluminum, or titanium, or any combination thereof.

15. A heat-quench distortion resistant laminate according to claim 6, wherein said alkali silicate inorganic resin composition is said c) composition;
wherein said reactive acidic glass, independently, comprises a borophosphosilicate, phosphate, phosphoborate, borophosphate, or a borate glass, or any combination thereof,
wherein said oxoanionic compound comprises, independently, phosphoric acid, boric acid, sulfuric acid, or potassium dihydrogen phosphate, or any combination thereof;
wherein said cations, independently, comprise magnesium, calcium, zinc, aluminum, or titanium, or any combination thereof.

16. A heat-quench distortion resistant laminate of claim 8, wherein said alkali silicate inorganic resin composition comprises a reaction product of the following:
about 30 to about 85 wt. % of said alkali silicate;
about 0.01 to about 20 wt. % of said acidic oxoanionic compound;
optionally about 0.1 wt. % to about 20 wt. % of said clay filler;
optionally about 0.01 wt. % to about 20 wt. % of said oxide; and
about 15 to about 60 wt. % of said water.

17. A heat-quench distortion resistant laminate of claim 10, wherein said alkali silicate inorganic resin composition comprises a reaction product of the following:
about 30 to about 85 wt. % of said alkali silicate;
about 0.01 to about 20 wt. % of said acidic oxoanionic compound;
optionally about 0.1 wt. % to about 20 wt. % of said clay filler;
optionally about 0.01 wt. % to about 20 wt. % of said oxide; and
about 15 to about 60 wt. % of said water.

18. The heat-quench distortion resistant laminate of claim 13, wherein said alkali silicate inorganic resin composition comprises a reaction product of the following:
about 30 to about 85 wt. % of said alkali silicate;
about 0.01 to about 20 wt. % of said acidic oxoanionic compound;
about 0.01 to about 60 wt. % of said reactive acidic glass;
optionally about 0.1 wt. % to about 20 wt. % of said clay filler;
optionally about 0.01 wt. % to about 20 wt. % of said oxide; and
about 15 to about 60 wt. % of said water.

19. The heat-quench distortion resistant laminate of claim 15, wherein said alkali silicate inorganic resin composition comprises a reaction product of the following:
about 30 to about 85 wt. % of said alkali silicate;
about 0.01 to about 20 wt. % of said acidic oxoanionic compound;
about 0.01 to about 60 wt. % of said reactive acidic glass;
optionally about 0.1 wt. % to about 20 wt. % of said clay filler;
optionally about 0.01 wt. % to about 20 wt. % of said oxide; and
about 15 to about 60 wt. % of said water.

20. The heat-quench distortion resistant laminate of claim 11, wherein said laminate is a portion of an exhaust pipe.
